(19) United States
(12) Patent Application Publication
(10) Pub. No.: US 2026/0019109 A1
(43) Pub. Date: Jan. 15, 2026

(54) SYSTEMS, METHODS, AND DEVICES FOR SELECTION OF RECONFIGURABLE INTELLIGENT SURFACES (RIS)

(71) Applicant: Apple Inc., Cupertino, CA (US)

(72) Inventors: Boqiang FAN, San Diego, CA (US); Mithat C. DOGAN, San Jose, CA (US); Wanlu SUN, San Diego, CA (US); Sharad SAMBHWANI, San Diego, CA (US)

(21) Appl. No.: 18/773,527

(22) Filed: Jul. 15, 2024

(51) Int. Cl. H04B 7/04; H04B 17/309; H04B 17/318

(52) U.S. Cl. CPC H04B 7/04013; H04B 17/328; H04B 17/346; H04B 17/347

(57) ABSTRACT

The techniques described herein can include solutions for selection of reconfigurable intelligent surfaces (RISs). RIS selection can be performed by a base station and/or a user equipment (UE). RIS selection can be directed to reducing signal degradation, addressing dynamic signal blocking, reducing outage probabilities, interference, and more. RIS selection can include selection of signaling resources, such as channels, bands, and sub-bands.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks can be developed to implement fourth generation (4G), fifth generation (5G) or new radio (NR) technology. Such technology can include solutions for enabling user equipment (UE) and network devices, such as base stations, to communicate with one another. Some scenarios can involve communication between a UE, base station, and one or more intermediary devices, such as reconfigurable intelligent surfaces (RISs).

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and can mean at least one, one or more, etc.

FIG. 1 is a diagram of an example of an overview according to one or more implementations described herein.

FIG. 2 is a diagram of an example network according to one or more implementations described herein.

FIG. 3 is a diagram of an example of selection of reconfigurable intelligent surfaces (RISs) according to one or more implementations described herein.

FIG. 4 is a diagram of an example process for selection of RISs according to one or more implementations described herein.

FIG. 5 is a diagram of an example of selection of RISs according to one or more implementations described herein.

FIG. 6 is a diagram of an example process for selection of RISs according to one or more implementations described herein.

FIG. 7 is a diagram of an example of selection of RISs according to one or more implementations described herein.

FIG. 8 is a diagram of an example process for selection of RISs according to one or more implementations described herein.

FIG. 9 is a diagram of an example of components of a device according to one or more implementations described herein.

FIG. 10 is a diagram of example interfaces of baseband circuitry according to one or more implementations described herein.

FIG. 11 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 12 is a diagram of an example process for selection RISs according to one or more implementations described herein.

FIG. 13 is a diagram of an example process for selection RISs according to one or more implementations described herein.

FIG. 14 is a diagram of an example process for selection RISs according to one or more implementations described herein.

FIG. 15 is a diagram of an example process for selection RISs according to one or more implementations described herein.

FIG. 16 is a diagram of an example process for selection RISs according to one or more implementations described herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

Telecommunication networks can include user equipment (UEs) capable of communicating with base stations and/or other network access nodes. UEs and base stations can implement various techniques and communications standards for enabling UEs and base stations to discover one another, establish and maintain connectivity, and exchange information in an ongoing manner. Objectives of such techniques can include selection of reconfigurable intelligent surfaces (RISs) for communication.

Wireless signals between wireless devices (e.g., UEs and/or base stations) can involve a reconfigurable intelligent surface (RIS) (also referred to as a large intelligent surface (LIS), smart reflect-array, intelligent passive mirrors, artificial radio space, reconfigurable metasurface, holographic multiple input multiple output (MIMO), etc.). An RIS can be an array of configurable elements known as metamaterial cells or unit cells. A metamaterial can be a material engineered to change properties in order to manipulate an amplitude, phase, or another characteristic of a wave or signal incident on the metamaterial. This can be achieved by, for example, changing an impedance or relative permittivity (and/or permeability) of the metamaterial. At lower frequencies, the impedance can be controlled through lumped elements like PIN diodes, varactors, transistors, microelectromechanical system (MEMS), etc. At higher frequencies, the relative permittivity and/or permeability of the material element (e.g., liquid crystal at high frequencies and graphene at even higher frequencies) can change in accordance with changes in a bias voltage provided to the material. Consequently, the phase of the signal redirected by the material is changed in accordance with the change in permittivity. As the bias voltages involved for these materials can be somewhat low, the materials can be often referred to as passive phase shifters.

A RIS can be used to improve communication between a base station and UE. Multiple RISs can be available for communications between a base station and UE; however, each RIS may not perform equally. Thus, selecting an appropriate RIS is meaningful. Additionally, signals between a base station, RIS, and UE can add up to be constructive or destructive, depending on phases of specific bands. Determination of composite channels can require direct measurements and/or very accurate knowledge of the channels, bands, and/or sub-bands. Such accurate measurements can be challenging or impractical to acquire before selecting the one or more RISs.

While currently available technologies may attempt to provide solutions for selecting a RIS to facilitate communications between a base station and a UE, such solutions include one or more deficiencies. For example, currently available technologies provide no or inadequate solutions for selecting RISs without detailed channel information, significant measurements, and/or other types of cumbersome and inefficient prerequisites. Such technologies are therefore unsatisfactory and can be counterproductive.

One or more of the techniques described herein provide solutions for selecting RISs based on simple measurements of signals between a base station and UE, and slow-varying RIS information. Examples of this type of information may include RIS capabilities (e.g., RIS gain, size, etc.) and geometric information (e.g., RIS location, etc.) A base station can provide RIS selection information to the UE. The UE can select, based on the RIS selection information and one or more constraints, one or more RISs for communication with the base station, and indicate the selection to the base station. The selection can be based on measurements of the base station included as part of the RIS selection information and measurements performed by the UE. The base station can select one or more RISs for communication and configure the RISs and the UE. When selecting the RISs, the base station can consider the recommendation from the UE as well as additional constraints. In some examples, the UE can configure the one or more selected RISs. In some examples, the UE and base station can exchange channel measurements. In some examples, the UE can simultaneously select one or more sub-bands for each of the RISs, and one or more RISs. In some examples, an interference device can manage configuration of the one or more RISs.

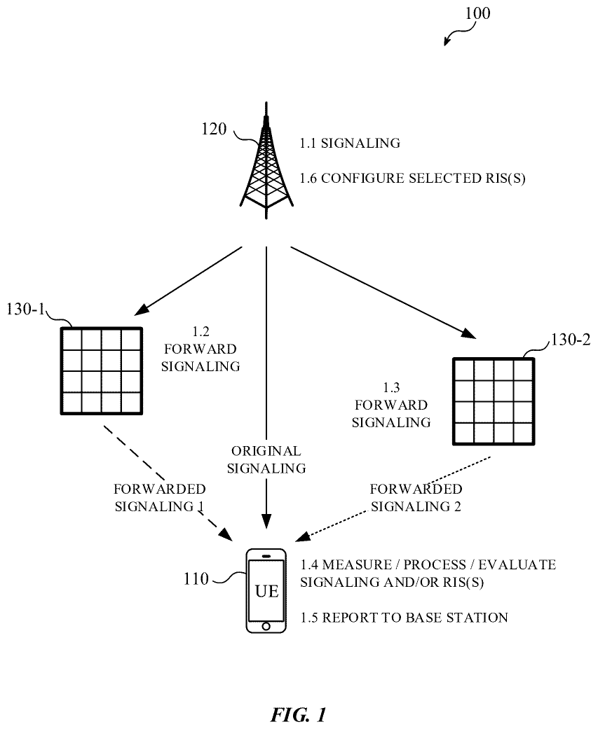

FIG. 1 is a diagram of an example of an overview 100 according to one or more implementations described herein. As shown, overview 100 can include UE 110, base station 120, RIS 130-1 and RIS 130-2. Base station 120 can communicate signaling information to UE 110, RIS 130-1 and RIS 130-2 (at 1.1). Base station 120 can also provide UE 110 with information about the network and about RIS 130-1 and 130-2. RIS 130-1 can forward signaling to the UE 110 (at 1.2). In some examples, RIS 130.1 can apply a first modulation scheme to the signaling to generate forwarded signaling 1. RIS 130-2 can forward signaling to the UE 110 (at 1.3). In some examples, RIS 130-2 can apply a second modulation scheme to the signaling to generate forwarded signaling 2.

UE 110 can receive the original or direct reference signal from base station 120, forwarded signaling 1 from RIS 130-1, and forwarded signaling 2 from RIS 130-2. Path delays and other signaling characteristics can vary between different signaling paths, such as the path from base station 120 to RIS 130-1 to UE 110, the path from base station 210 to RIS 130-2 to UE 110, and the path from base station 120 to UE 110. UE 110 can measure, process, and/or evaluate signals of the different paths for different characteristics or qualities (at 1.4). Examples of this information may include a path loss, delay, angle of arrival (AOA), angle of departure (AOD), time difference of arrival (TDOA), signal interference, etc. Depending on the implementation, UE 110 can provide base station 120 with the characteristics or qualities, provide base station 120 with RIS recommendations or selections, and more (at 1.5). Base station 120 can select and/or configure one or more of RISs 130 based on the information (e.g., measurements, RIS recommendations, RIS selections, etc.) received from UE 110 (at 1.6). These and many other features and aspects of the techniques described herein are presented below with reference to remaining Figures.

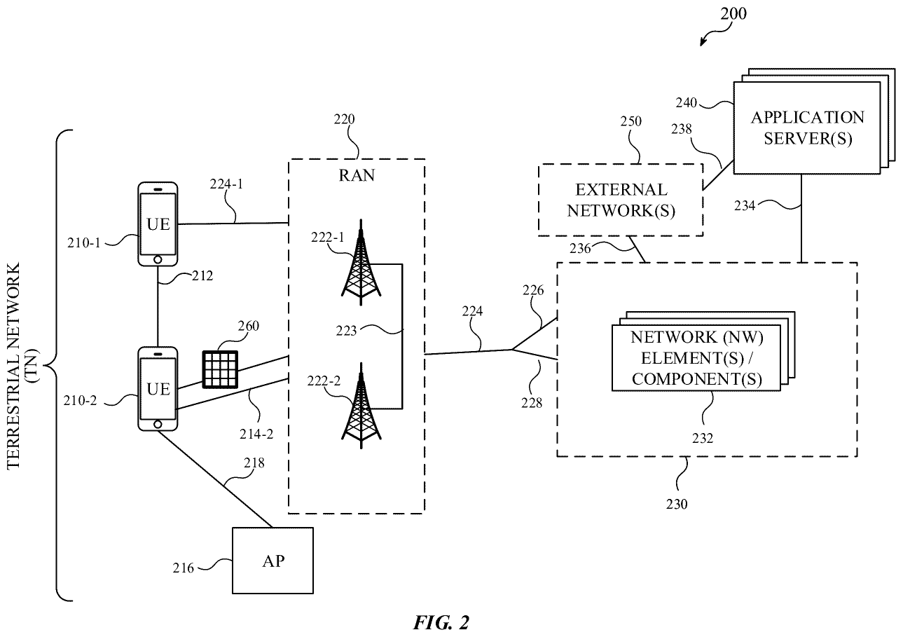

FIG. 2 is an example network 200 according to one or more implementations described herein. Example network 200 can include UEs 210, 210-2, etc. (referred to collectively as “UEs 210” and individually as “UE 210”), a radio access network (RAN) 220, a core network (CN) 230, application servers 240, and external networks 250.

The systems and devices of example network 200 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 can include smartphones (e.g., handheld touchscreen mobile computing devices connectable to one or more wireless communication networks). Additionally, or alternatively, UEs 210 can include other types of mobile or non-mobile computing devices capable of wireless communications, such as personal data assistants (PDAs), pagers, laptop computers, desktop computers, wireless handsets, etc. In some implementations, UEs 210 can include internet of things (IoT) devices (or IoT UEs) that can comprise a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network. UEs 210 can communicate and establish a connection with one or more other UEs 210 via one or more wireless channels 212, each of which can comprise a physical communications interface/layer. The connection can include an M2M connection, MTC connection, D2D connection, SL connection, etc. The connection can involve a PC5 interface. In some implementations, UEs 210 can be configured to discover one another, negotiate wireless resources between one another, and establish connections between one another, without intervention or communications involving RAN node 222 or another type of network node. In some implementations, discovery, authentication, resource negotiation, registration, etc., can involve communications with RAN node 222 or another type of network node.

UEs 210 can use one or more wireless channels 212 to communicate with one another. As described herein, UE 210 can communicate with RAN node 222 to request SL resources. RAN node 222 can respond to the request by providing UE 210 with a dynamic grant (DG) or configured grant (CG) regarding SL resources. A DG can involve a grant based on a grant request from UE 210. A CG can involve a resource grant without a grant request and can be based on a type of service being provided (e.g., services that have strict timing or latency requirements). UE 210 can perform a clear channel assessment (CCA) procedure based on the DG or CG, select SL resources based on the CCA procedure and the DG or CG; and communicate with another UE 210 based on the SL resources. The UE 210 can communicate with RAN node 222 using a licensed frequency band and communicate with the other UE 210 using an unlicensed frequency band.

UEs 210 can communicate and establish a connection with (e.g., be communicatively coupled) with RAN 220, which can involve one or more wireless channels 214-1 and 214-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different RAN network nodes (e.g., RAN network nodes 222-1 and 222-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 230. Additionally, at least one of the MN or the SN can be operated with shared spectrum channel access, and functions specified for UE 210 can be used for an integrated access and backhaul mobile termination (IAB-MT). Similar for UE 210, the IAB-MT can access the network using either one network node or using two different nodes with enhanced dual connectivity (EN-DC) architectures, new radio dual connectivity (NR-DC) architectures, or the like. In some implementations, a base station (as described herein) can be an example of network RAN network nodes.

As shown, UE 210 can also, or alternatively, connect to access point (AP) 216 via connection interface 218, which can include an air interface enabling UE 210 to communicatively couple with AP 216. AP 216 can comprise a wireless local area network (WLAN), WLAN node, WLAN termination point, etc. The connection 216 can comprise a local wireless connection, such as a connection consistent with any IEEE 702.11 protocol, and AP 216 can comprise a wireless fidelity (Wi-Fi®) router or other AP. While not explicitly depicted in FIG. 2, AP 216 can be connected to another network (e.g., the Internet) without connecting to RAN 220 or CN 230. In some scenarios, UE 210, RAN 220, and AP 216 can be configured to utilize LTE-WLAN aggregation (LWA) techniques or LTE WLAN radio level integration with IPsec tunnel (LWIP) techniques. LWA can involve UE 210 in RRC_CONNECTED being configured by RAN 220 to utilize radio resources of LTE and WLAN. LWIP can involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling can include encapsulating the entirety of original IP packets and adding a new packet header, thereby protecting the original header of the IP packets.

RAN 220 can include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 can include network access points configured to provide radio baseband functions for data and/or voice connectivity between users and the network based on one or more of the communication technologies described herein (e.g., 2G, 3G, 4G, 5G, WiFi®, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 can include a roadside unit (RSU), a transmission reception point (TRxP or TRP), and one or more other types of ground stations (e.g., terrestrial access points). In some scenarios, RAN node 222 can be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 222; a media access control (MAC)/physical (PHY) layer split wherein RRC, PDCP, radio link control (RLC), and MAC layers can be operated by the CRAN/vBBUP and the PHY layer can be operated by individual RAN nodes 222; or a “lower PHY” split wherein RRC, PDCP, RLC, MAC layers and upper portions of the PHY layer can be operated by the CRAN/vBBUP and lower portions of the PHY layer can be operated by individual RAN nodes 222. This virtualized framework can allow freed-up processor cores of RAN nodes 222 to perform or execute other virtualized applications.

In some implementations, an individual RAN node 222 can represent individual gNB-distributed units (DUs) connected to a gNB-control unit (CU) via individual F1 or other interfaces. In such implementations, the gNB-DUs can include one or more remote radio heads or radio frequency (RF) front end modules (RFEMs), and the gNB-CU can be operated by a server (not shown) located in RAN 220 or by a server pool (e.g., a group of servers configured to share resources) in a similar manner as the CRAN/vBBUP. Additionally, or alternatively, one or more of RAN nodes 222 can be next generation eNBs (i.e., gNBs) that can provide evolved universal terrestrial radio access (E-UTRA) user plane and control plane protocol terminations toward UEs 210, and that can be connected to a 5G core network (5GC) 230 via an NG interface.

Any of the RAN nodes 222 can terminate an air interface protocol and can be the first point of contact for UEs 210. In some implementations, any of the RAN nodes 222 can fulfill various logical functions for the RAN 220 including, but not limited to, radio network controller (RNC) functions such as radio bearer management, uplink and downlink dynamic radio resource management and data packet scheduling, and mobility management. UEs 210 can be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

In some implementations, a downlink resource grid can be used for downlink transmissions from any of the RAN nodes 222 to UEs 210, and uplink transmissions can utilize similar techniques. The grid can be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block can comprise a collection of resource elements (REs); in the frequency domain, this can represent the smallest quantity of resources that currently can be allocated. There are several different physical downlink channels that are conveyed using such resource blocks.

Further, RAN nodes 222 can be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity. Whether a particular frequency band corresponds to a licensed medium or an unlicensed medium can depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 can operate using stand-alone unlicensed operation, licensed assisted access (LAA), eLAA, and/or feLAA mechanisms. In these implementations, UEs 210 and the RAN nodes 222 can perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations can be performed according to a listen-before-talk (LBT) protocol.

The PDSCH can carry user data and higher layer signaling to UEs 210. The physical downlink control channel (PDCCH) can carry information about the transport format and resource allocations related to the PDSCH channel, among other things. The PDCCH can also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) can be performed at any of the RAN nodes 222 based on channel quality information fed back from any of UEs 210. The downlink resource assignment information can be sent on the PDCCH used for (e.g., assigned to) each of UEs 210.

One or more of the techniques described herein can enable selection of RIS 260. In some examples, there can be multiple of RIS 260. RIS 260 can be a device that includes a wired and/or wireless network interface, a controller (that includes a memory, storage device, one or more processors, and other components, that are capable of receiving configuration information and implementing the configuration information. The configuration information can be implemented as a signal modulation scheme that is configured to manage a set of configurable elements arranged in a linear array or a planar array. A linear array can be a vector of N configurable elements and a planar array can be a matrix of N×M configurable elements, where N and M are integer values. The configurable elements can have the ability to redirect a wave or signal that is incident on the linear or planar array by changing the phase of the wave/signal. The configurable elements can also be capable of changing the amplitude, polarization, frequency resources, or time resources of the wave or signal.

The RAN nodes 222 can be configured to communicate with one another via interface 223. In implementations where the system is an LTE system, interface 223 can be an X2 interface. In NR systems, interface 223 can be an Xn interface. The X2 interface can be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface can include an X2 user plane interface (X2-U) and an X2 control plane interface (X2-C). The X2-U can provide flow control mechanisms for user data packets transferred over the X2 interface and can be used to communicate information about the delivery of user data between eNBs or gNBs. For example, the X2-U can provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

As shown, RAN 220 can be connected (e.g., communicatively coupled) to CN 230. CN 230 can comprise a plurality of network elements 232, which are configured to offer various data and telecommunications services to customers/subscribers (e.g., users of UEs 210) who are connected to the CN 230 via the RAN 220. In some implementations, CN 230 can include an evolved packet core (EPC), a 5G CN, and/or one or more additional or alternative types of CNs. The components of the CN 230 can be implemented in one physical node or separate physical nodes including components to read and execute instructions from a machine-readable or computer-readable medium (e.g., a non-transitory machine-readable storage medium). In some implementations, network function virtualization (NFV) can be utilized to virtualize any or all the above-described network node roles or functions via executable instructions stored in one or more computer-readable storage mediums (described in further detail below). A logical instantiation of the CN 230 can be referred to as a network slice, and a logical instantiation of a portion of the CN 230 can be referred to as a network sub-slice. Network Function Virtualization (NFV) architectures and infrastructures can be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

As shown, CN 230, application servers 240, and external networks 250 can be connected to one another via interfaces 234, 236, and 238, which can include IP network interfaces. Application servers 240 can include one or more server devices or network elements (e.g., virtual network functions (VNFs) offering applications that use IP bearer resources with CM 230 (e.g., universal mobile telecommunications system packet services (UMTS PS) domain, LTE PS data services, etc.). Application servers 240 can also, or alternatively, be configured to support one or more communication services (e.g., voice over IP (VoIP) sessions, push-to-talk (PTT) sessions, group communication sessions, social networking services, etc.) for UEs 210 via the CN 230. Similarly, external networks 250 can include one or more of a variety of networks, including the Internet, thereby providing the mobile communication network and UEs 210 of the network access to a variety of additional services, information, interconnectivity, and other network features.

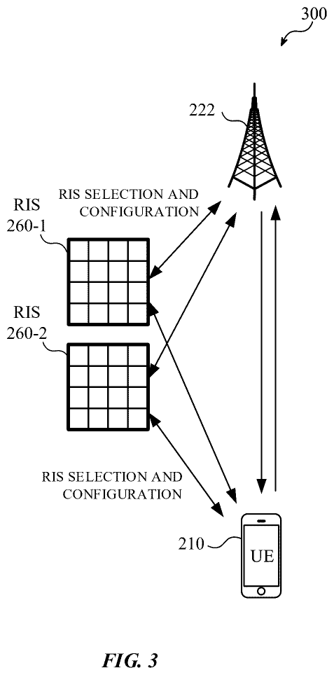

FIG. 3 is a diagram of an example 300 of selection of RISs 260 according to one or more implementations described herein. As shown, base station 222 or UE 210 can select and configure one or more of RISs 260 for communications. RISs 260 can be used to enhance communications between a UE 210 and a base station 222. There can be multiple RISs 260 available for communications, and base station 222, and UE 210 can determine which RISs 260 are optimal for communications.

When accurate channel measurements are not available, selecting a RIS 260 arbitrarily can cause potential degradation to the performance of the communications. A RIS selection protocol is described herein to select one or more RISs 260 without reliance on exhaustive knowledge of the corresponding channel, which can result in improved spectral efficiency and avoid potential degradation. In some examples, techniques described herein may not rely on exhaustive channel measurements to minimize the outage probability during RIS selection. The techniques can further include RIS selection strategies for other applications for joint sub-band selection and interference management.

Communication paths between base station 222 and UE 210 via one or more RISs 260 can be constructive or destructive depending on phases of specific bands. In some examples, determination of composite channels can require direct measurements, or very accurate knowledge, of separate channels between base station 222 and UE 210 (e.g., a BS-UE path), and the channels between base station 222, UE 230, and RISs 260 (e.g., a BS-RIS-UE path). However, acquiring such measurements and knowledge before RIS selection can be challenging. For example, channel measurements and knowledge can be outdated for a time-varying channel, requiring constant updating and overhead. In some examples, measuring RIS channels can require significant beam training overhead for each RIS 260.

Therefore, in some examples, it can be advantageous to select one or more RISs 260 based on simple measurements and slow-varying RIS information, such as RIS capability (e.g., RIS gain, size, etc.), and geometric information (e.g., RIS location, etc.) Techniques described herein provide for selecting one or more RISs 260 with reduced overhead and measurements. The selection of \RISs 260 can be further based on various criteria.

For example, a RIS can be selected based on the frequency-selectivity property of the composite channel. When a RIS 260 is used to aid communication from base station 222 to UE 210, UE 210 can receive a superposition of signals via both the path from base station 222 to UE 210 (BE-UE path) and the path from base station 222 to RIS 260 to UE 120 (BE-RIS-UE path). Such superposition can be described by the following.

$$r ( t ) = s ( t ) ( {h}_{0} \cdot δ ( t ) + h \cdot δ ( t - τ ) ) + n ( t )$$

The r(t) can represent a signal received at UE 210. The s(t) can represent a signal transmitted by base station 222. The channel associated with the BS-UE path can be represented by h₀·δ(t), where h₀ is a channel and δ(t) is a distribution of time associated with the channel. The channel associated with a BS-RIS-UE path can be represented by h·δ(t−τ), where h is the channel and δ(t−τ) is a distribution of a difference between time (t) and a delay between base station 222 and UE 210 (τ). The n(t) can describe signal noise.

A frequency domain R(f) can be represented by the following.

$$R ( f ) = S ( f ) \cdot ( {h}_{0} + h \cdot {e}^{- j 2 π f τ} ) + N ( f )$$

S(f) can describe a frequency of UE 210; j can be a constant; f can be a frequency; and N(f) can describe signal noise. A composite channel of the RIS-aided link can be frequency-selective. A period of the channel frequency response can be 1/τ Hertz. For a frequency-selective channel, a worst signal-to-noise ratio (SNR) can be proportional to (|h₀|−|h|)², while a best SNR can be proportional to (|h₀|+|h|)². A worst-case SNR can result from destructive superposition, and in some examples, can be worse than the SNR without the presence of RIS 260. When an accurate channel estimation is challenging, a period of channel frequency response, 1/τ, can be minimized or reduced to help prevent an allocated band from suffering from a worst-case SNR. This can be accomplished by increasing the number of periods covered by the band so that destructive superposition effects can be mitigated. When a bandwidth is sufficiently large with respect to the period of channel frequency response, 1/τ, the average SNR can be proportional to |h₀|²+|h|².

For example, frequency selectivity for a comprises RIS channel, it can be assumed that the random complex channels h₀ and h satisfy |h₀|²=|h|²=10 dB. The delay τ and noise power due to fast-fading or time-varying channel can be represented by setting σ²=1, where σ² is noise power. In a specific example, it can be assumed that there is a 50 MHz bandwidth and a path length difference between 0 m and 24 m (up to a delay difference of 80 nsec). In such an example, the channel capacity (mean spectral efficiency) can be represented by the following equation for a set of subcarriers in the band (fₙ).

$$C ∝ {\sum }_{n} {log}_{2} ( 1 + {\vert {h}_{0} {e}^{- j 2 π {f}_{n} {τ}_{0}} + {he}^{- j 2 π {f}_{n} τ} \vert}^{2} / {σ}^{2} ) , {f}_{n}$$

When the delay difference τ is large enough, a robust channel capacity improvement can be achieved regardless of constructive/destructive superposition between paths. In such examples, the channel capacity converges to the mean when τ increases. When the delay difference between two paths is too small, the channel is opportunistic. In such examples, channel capacity can be even worse than the case without RISs 260, which needs to be avoided in RIS selection.

In some examples, there can be a threshold of delay, or path length, difference. A threshold for delay (or a path length) difference between a BS-UE and BS-RIS-UE channel can determine whether channel degradation can happen. The threshold value can increase as BS-UE SNR increases and BS-RIS-UE SNR decreases. When the BS-UE SNR is high, RISs 260 with channels with lower SNRs can enable robust channel improvement. The gain difference of RIS path and direct path in decibels (dB) can be expressed as 20·log₁₀(|h|/|h₀|). RISs 260 with SNR smaller than BS-UE path can tend to cause channel degradation. In some examples, a threshold table dependent on BS-UE SNR and BS-RIS-UE SNR can be used for RIS selection.

Delay difference between BS-UE and BS-RIS-UE channel also determines the outage performance. For example, for a set of channels, assume h₀ and h are i.i.d. Rayleigh fading channels, and the mean SNR of h₀ is 4 dB. It can be further assumed that outage can happen when the channel capacity is smaller than a threshold as represented by the following.

$${\sum }_{n} {log}_{2} ( 1 + {\vert {h}_{0} {e}^{- j 2 π {f}_{n} {τ}_{0}} + {he}^{- j 2 π {f}_{n} τ} \vert}^{2} / {σ}^{2} ) \leq {C}_{th}$$

For an example, it can be assumed that Cₜₕ=N, where N is the number of subcarriers, which is equivalent to the capacity of 0 dB SNR. Other values of Cₜₕ can be used for outage evaluation. Given the same RIS SNR, the outage probability decreases when delay (path length) difference increase. In some examples, the outage probability converges as B|τ₀−τ|≥1, where B is the bandwidth. When SNRs of two RIS paths are similar, selecting RIS with larger |τ₀−τ| can result in lower outage probability.

In some examples, RIS selection can be based on path delay differences. When multiple RISs are available, one or multiple RISs 260 can be selected by base station 222 or UE 210 to aid communication. The selection can allow for performance improvement and avoid potential degradation. To avoid degradation, the selection can be based on the path delay difference between RIS path (BS-RIS-UE path) and the direct path (BS-UE path). RISs 260 with path delay differences larger than a threshold can enable robust improvement. With different combinations of BS-UE and BS-RIS-UE SNR, the path delay difference threshold is different. Selecting RISs 260 can be based on a path delay difference threshold that is dependent on SNR. Further, RIS selection can optimize outage performance. For example, when SNRs of different RIS paths are similar, RISs 260 with a larger path delay difference can provide better outage performance. When accurate sub-band channel estimation is supported (e.g., for static channel or low overhead), RISs 260 and sub-band allocation can be selected jointly and RISs 260 can be selected for interference management.

As further described herein, UE 210, base station 222, or both, can select one or more RISs 260. The selection can be based on criteria, conditions, parameters, measurements, etc., to prevent degradation of the channel and improve communications. The criteria, conditions, parameters, measurements, etc., can include delay differences (e.g., path length differences) between BS-UE and BS-RIS-UE paths, outage probability minimization requirements, and more. In some examples, the criteria for RIS selection may include the time and frequency resources available for communication. The time and frequency resources may be resources of one or more RISs 260, base station 222, UE 210, or a combination. In some examples, techniques described herein can support joint selection of RISs 260 and sub-bands to counter frequency-selective channel and beam squinting effects. In some examples, techniques described herein can provide for selection of RISs for interference management.

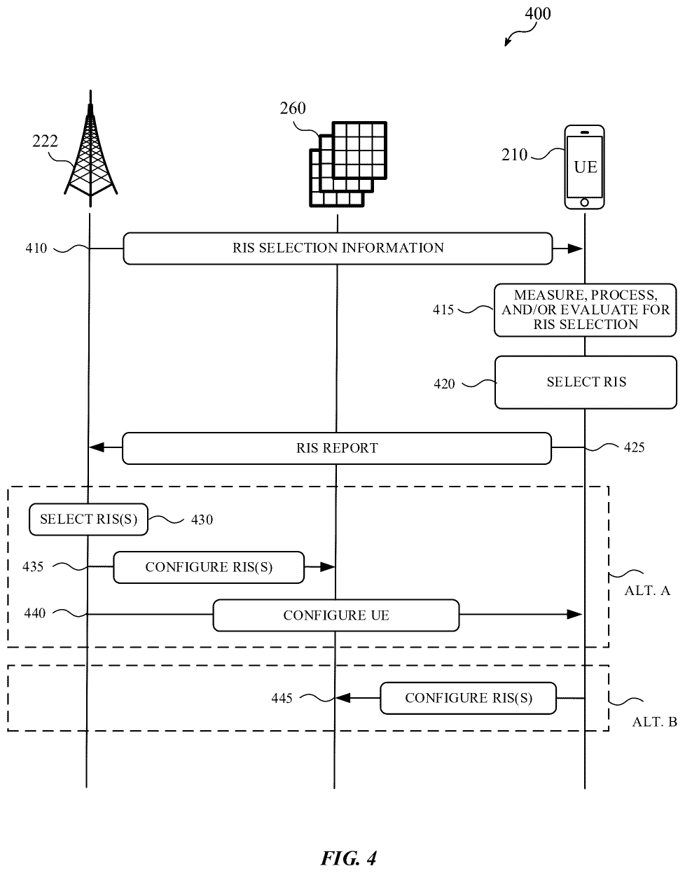

FIG. 4 is a diagram of an example process for RIS selection according to one or more implementations described herein. Process 400 can be implemented by UE 210, base station 222, and one or more RISs 260. In some implementations, some or all of process 400 can be performed by one or more other systems or devices, including one or more of the devices of FIG. 2. Additionally, process 400 can include one or more fewer, additional, differently ordered and/or arranged operations than those shown in FIG. 4. In some implementations, some or all of the operations of process 400 can be performed independently, successively, simultaneously, etc., of one or more of the other operations of process 400. Operations described below as being performed by a single base station can be performed by multiple base stations 222. Similarly, operations described below as being performed by a single RIS 260 can be performed by multiple RISs 260. As such, the techniques described herein are not limited to a number, sequence, arrangement, timing, etc., of the operations or processes depicted in FIG. 4. Techniques described with reference to FIG. 4 can provide for RIS selection without degradation.

Process 400 can include base station 222 communicating RIS selection information to UE 210 (block 410). The RIS selection information can be broadcast by the network, such as by base station 222, to UE 210. The RIS selection information can include a network map, locations of the one or more RISs 260, and capabilities of RISs 260. Capabilities can include size, beamforming gain, unit cell gain, etc. In some examples, the broadcast including the RIS selection information can be periodic or aperiodic. For example, the message can triggered by request of UE 210. In some examples, UE 210 can have information related to RIS selection, such as base station to UE (BS-UE) SNR (SNR₀), BS-UE delay (τ₀), the location of UE 210, previous channel measurements of communication with RISs 260, or a combination thereof.

Process 400 can include UE 210 can measuring, processing, and/or evaluating information for RIS selection (block 415). UE 210 can calculate the pathloss of the BS-RIS-US path (PL), the pathloss of the BS-UE path (P PL₀), the delay of the BS-RIS-UE path (τ), the angle-of-arrival (AOA) and angle-of-departure (AOD) of RIS 260 with respect to both base station 222 and UE 210, the RIS illumination (e.g., when RIS 260 is very large), or a combination thereof. Illumination can be used as a criteria for selecting RISs 260, and can represent the light transmitted by the RIS 260. Illumination can be created by the reflection of signals off of the RIS 260.

Process 400 can include UE 210 can select one or more RISs 260 (block 420). UE 210 can select one or more RISs 260 according to one or more constraints, criteria, conditions, parameters, etc. This can include that the BS-RIS-US path and the BE-UE path need to be covered by the same UE 210 beams, especially when a single radio frequency chain is used. The path delay difference of the BS-UE path (τ−τ₀) can be larger than a threshold (τₜₕ), as represented by the equation: |τ−τ₀|≥τₜₕ. The threshold can be predetermined and can be dependent on the BS-UE SNR and the SNR different between the BS-UE path and the BS-RIS-UE path. When selecting multiple RISs 260 (whether selected by UE 210 or base station 222), the thresholds of the different RISs 260 can be determined jointly.

Process 400 can include UE 210 can indicate the list to base station 222, such as part of a RIS report (block 425). UE 210 can indicate the list after determining which RISs 260 satisfy the one or more constraints, criteria, conditions, parameters, etc. Examples of the constraints, criteria, conditions, parameters, etc., are described herein with reference to one or more Figures.

In Alternative A (Alt. A), process 400 can include base station 222 selecting one or more RISs 260 (block 430). Base station 222 can select the one or more RISs 260 based on the RIS report from UE 210, constraints of UE 210, and other criteria, such as constraints of base station 222. For example, base station 222 can only select RISs 260 where both the BS-RIS-UE path and the BS-UE path need to be covered by the same BS beams, especially when a single radio frequency chain is used. When selecting multiple RISs 260 (whether selected by UE 210 or base station 222), the thresholds of the different RISs 260 can be determined jointly. Criteria for selecting the one or more RISs 260 can include criteria to optimize the selection, such as selecting based on the maximum SNR of the RIS-aided link, a balanced resource loaded of RIS 260, scheduling RIS 260 without conflict, authentication of RIS 260, low RIS 260 power consumption, or a combination thereof.

Process 400 can include base station 222 configuring the selected one or more RISs 260 (block 435) and notify, or configure, UE 210 (block 440). The configuration of the selected one or more RISs 260 can include transmission schedule, beam indication, and authentication. Process 400 can also include base station 222 notifying UE 210 of the selected one or more RISs 260 (block 440). Base station 222 can also, or alternatively, provide UE 210 with configuration information for communicating via the one or more RISs 260.

In Alternative B (Alt. B), process 400 can include UE 210 configuring the one or more selected RISs 260 (block 445). For example, the RIS selection information (block 410) can include information, such as the base width of base station 222, resource scheduling and load information of RISs 260, authentication information for RISs 260, power consumption of RISs 260, etc. With additional information, such as the foregoing, UE 210 can select RISs 260 (block 420) and notify base station 222 in the RIS report (block 425). UE 222 can configure the selected RISs 260 (block 445). In some examples, RISs 260 selected by UE 210 can be configured by base station 222. When UE 210 and/or one or more RISs 260 are mobile, the RIS selection can be updated dynamically. For example, UE 210 can send a trigger signal to base station 222 to begin the selection process. The trigger signal can be a request for the IRS selection information from UE 210 to base station 222.

When selecting one or more RISs 260, whether by base station 222 or UE 210, delay difference thresholds can be considered. A delay difference threshold can be calculated based on the total channel capacity of all subcarriers. The variable fₙ can represent each subcarrier, and the variable N can represent the total number of subcarriers. An SNR value can indicate the SNR of the various paths, and a PL value can represent the pathloss of the various paths. A value of

$$\{ {τ}_{th}^{( i )} \}$$

can describe the combination of all maximum values of τᵢ that satisfy the inequality of the following, which holds true when performance degradation occurs after selecting RIS.

$${min}_{{θ}_{i} ∈ [ 0 , 2 π ]} {\sum }_{n} {log}_{2} ( 1 + {\vert \sqrt{{SNR}_{0}} {e}^{- j 2 π {f}_{n} {τ}_{0}} + {\sum }_{i} \sqrt{{SNR}_{0} * {PL}_{i} / {PL}_{0}} {e}^{- j 2 π {f}_{n} {τ}_{i}} {e}^{j {θ}_{i}} \vert}^{2} ) \leq N {log}_{2} ( 1 + {SNR}_{0} )$$

In some examples, process 400 can support RIS selection for minimal outage probability. For example, UE 210 can select one or more RISs 260 (block 420) based on an ordered list of RISs 260 to minimize outage probability. UE 210 can consider additional constraints, such as maintaining an outage threshold (e.g., capacity, SNR). The threshold can be specific to a particular scenario or application. UE 210 can send the RIS list ordered according to the calculated OESNRs to base station 222 (block 425).

UE 210 can calculate an outage-effective SNR (OESNR) for each RIS 260 (block 415). The outage probability of each RIS 260 can correspond to the OESNR. UE 210 can estimate the SNR of each RIS path according to the following equation.

$$SNR = {SNR}_{0} * PL / {PL}_{0}$$

UE 210 can further compare each SNR to an inequality. When the bandwidth multiplied by a path delay difference is greater than one, the OESNR can be equal to the SNR. When the bandwidth multiplied by the difference of path loss is less than one, the OESNR can be equal to the SNR and an additional factor of ε. The inequalities can be described by the following.

$$If B \vert {τ}_{0} - τ \vert \geq 1 , OESNR = SNR$$

$$If B \vert {τ}_{0} - τ \vert < 1 , OESNR = SNR + ε$$

The value of ε can be based on SNR, SNR₀, |τ₀−τ|, and outage threshold OTH, and can be determined by a predetermined table or other type of data structure. Different paths may or may not satisfy the corresponding thresholds. For example, a RIS path with a 2 dB SNR and a larger path delay difference can satisfy the inequity B|τ₀−τ|≥1, meaning that OESNR=SNR=2 dB. For another RIS path with an 8 dB SNR and smaller path delay difference |τ₀−τ|, the OESNR=SNR+ε and can also be 2 dB and ε=−6 dB. In such examples, The outage probabilities of both RIS paths can be the same, and OESNR can be defined to have the same value. Such ε values can be predetermined based on experimentation, or other calculations, which can be calculated in advance and saved as a table or other data structure in UE 210. In other implementations, ε values can be determined dynamically (e.g., in real-time).

Process 400 can include base station 222 receiving the RIS report from UE 210 (block 425). The RIS report can include RISs 260 ordered according to OESNR. Base station 222 can select one or more RISs 260 (block 430) based on various constraints (e.g. such that both the BS-RIS-UE path and BS-UE path are covered by the same base station beams, especially when a single radio frequency chain is used). Base station 222 can evaluate for RISs 260 satisfying one or more constraints, criteria, conditions, parameters, etc., and can select RISs 260 for maximal OESNR. Other constraints, criteria, conditions, parameters, etc., can be integrated to optimize the selection of one or more RISs 260, such as load (resource)/schedule of RIS 260, authentication of RIS 260, RIS power consumption, and more. Authentication if RIS 260 can include confirming the identity and location of RIS 260. The load schedule, or resource schedule, can be one of one or more resource parameters. Other resource parameters can include resource time and frequency and resource scheduling. Base station 222 can notify UE 210 (440) and configure the selected RISs 260 (435). In some examples, UE 210 can configure RISs 260 (block 445, Alt. B). Techniques described with reference to FIG. 4 can be extended to RIS-aided MIMO systems.

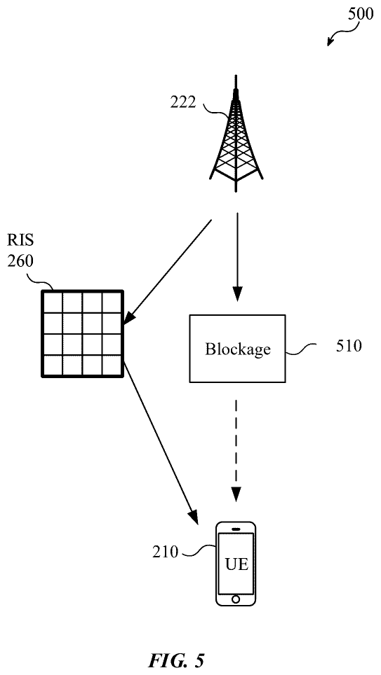

FIG. 5 is a diagram of an example 500 of selection of RISs 260 according to one or more implementations described herein. Example 500 refers to a scenario of dynamic blockage, represented by blockage 500. Dynamic blockage can include a physical object or other environmental feature, such as a person or a car, between base station 222 and UE 210. When RIS 260 is used to aid communication from base station 222 to UE 210, UE 210 can receive the superposition of signals via both the BS-UE path and the BS-RIS-UE path. When there is a dynamic blockage, such as blockage 510, in the BS-UE path, base station 222 and UE 222 can maintain a link with the aid of RIS 260 via the BS-RIS-UE path. The BS-RIS-UE path and the BE-UE path can be separated to avoid interference or interruption created by blockage 510.

Additional angular separation constraints can be applied to RIS selection (by base station 222 and/or UE 210) when there is dynamic blockage. For example, angular separation constraints can be applied on the transmission and reception sides, when a maximal AOD/AOA differences between any two paths (either the BS-RIS-UE or BS-UE path) is larger than corresponding thresholds Th_{AOD} and Th_{AOA}. The thresholds Th_{AOD} and Th_{AOA} can be minimal angle differences for avoiding blockage in similar directions. The constraints for RIS selection can include thresholds acquired from channel estimation, channel sensing, image object detection, etc. Some constraints can include mean differences of AOD/AOA being larger than thresholds and minimal differences of AOD/AOA being larger than thresholds.

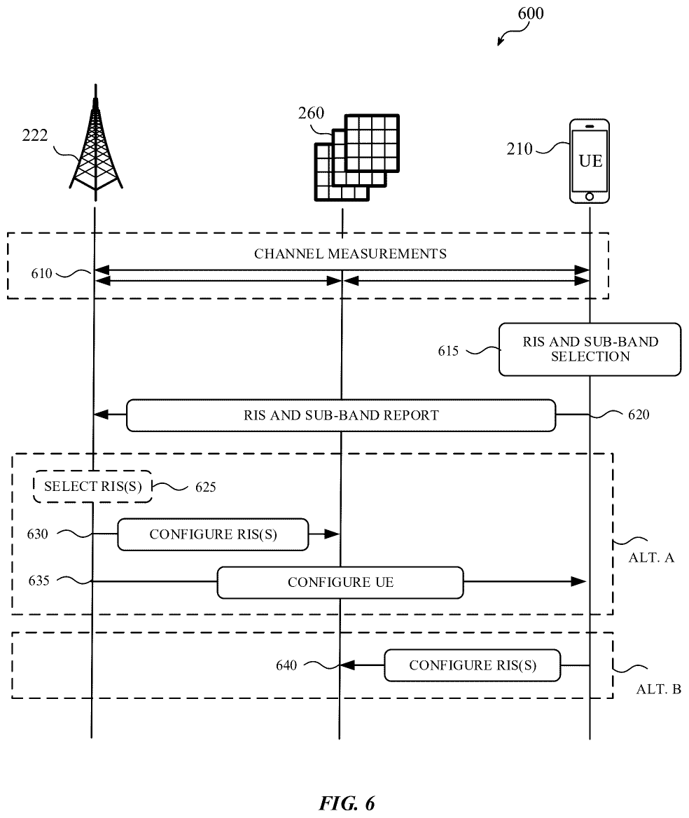

FIG. 6 is a diagram of an example 600 of selection of RISs 260 according to one or more implementations described herein. Process 600 describes joint RIS selection and sub-band allocation. Process 600 can be implemented by UE 210, base station 222, and one or more RISs 260. In some implementations, some or all of process 600 can be performed by one or more other systems or devices, including one or more of the devices of FIG. 2. Additionally, process 600 can include one or more fewer, additional, differently ordered and/or arranged operations than those shown in FIG. 6. In some implementations, some or all of the operations of process 600 can be performed independently, successively, simultaneously, etc., of one or more of the other operations of process 600. Operations described below as being performed by a single base station can be performed by multiple base stations 222. Similarly, operations described below as being performed by a single RIS 260 can be performed by multiple RISs 260. As such, the techniques described herein are not limited to a number, sequence, arrangement, timing, etc., of the operations or processes depicted in FIG. 6. Techniques described with reference to FIG. 6 can provide for RIS selection without degradation.

Sub-bands can be selected for RIS-aided communications. When accurate sub-band channel estimation is supported, a preferred sub-band for RIS-aided communication can be selected based on one or more conditions, such as a preferred SNR, RSRP, etc. The SNR of preferred sub-band can be proportional to (|h₀|+|h|)². In applications with single data stream, when multiple RISs 260 can be selected, the same sub-bands need to be applicable to all selected RISs 260. In such examples, it can be necessary to consider the corresponding delay profiles.

RIS-aided communications can experience beam squinting. When the bandwidth is large, the beam pattern on each sub-band can be different. The beamforming gain in a steering direction on sub-bands far from a center frequency can degrade, such that a strong beam squinting effect is to be avoided. The beam squinting effect can depend on bandwidth, RIS array size, and path distance between devices. When sub-band channel estimation is supported, the beam squinting effect can be measured, and the best sub-band for RIS-aided communication can be selected.

Process 600 can include UE 210 and base station 222 measuring the channel of the BS-UE path and the BS-RIS-UE path (block 610). The measurements can include sub-band SNR, path loss, RSRP, TDOA, and delay difference estimation. Base station 222, UE 210, or both, can share the measurements with the node responsible for RIS/sub-band selection, and with RIS 260. For example, base station 222 can share channel measurements with UE 210, and vice versa. In some examples, base station 222 can indicate RIS selection information, sub-band selection information, or both, to UE 210.

Process 600 can include UE 210 jointly selecting one or more RISs 260 and associated sub-bands (block 615). For example, UE 210 can jointly select m-th RIS and sub-band B_{S} based on the following.

$$arg {max}_{m , {B}_{S}} SNR ( m , {B}_{S} )$$

The SNR on each sub-band can be determined by combining channel measurements, as based on the following.

$$SNR ( \{ {m}_{i} \} , {B}_{S} ) = {\vert {h}_{0} ( {B}_{S} ) + {\sum }_{{m}_{i}} h ( {m}_{i} , {B}_{S} ) \vert}^{2} / {N}_{0}$$

The portion h(mᵢ, B_{S}) can represent a channel of BS-RIS(mᵢ)-UE, the variable h₀(B_{S}) can represent a channel of BS-UE, and the N₀ can be a noise (and interference) power. In some examples, the selection can also be based on one or more additional or alternative metrics, such as overall path loss, RSRP, channel capacity, etc. UE 210 can thus utilize peaks of the frequency selective channel.

Process 600 can include UE 210 reporting the measurements and selection to base station 222 as part of the RIS and sub-band report (block 620). In some implementations, the criteria for selecting a single RIS 260 can be generalized to select multiple RISs 260 simultaneously. For example, channel measurements can be combined by summing each channel h(mᵢ, B_{S}) of each BS-RIS(mᵢ)-UE path. Metrics for RIS selection such as overall path loss, RSRP, channel capacity can be calculated, summed, or otherwise considered for multiple RISs 260 simultaneously.

Referring to Alt. A, in some implementations process 600 can include base station 222 selecting RISs 260 (block 625). The selection of the sub-band can also be performed by base station 222. In some examples, base station 222 can use the recommendation of RISs 260 and sub-band report from UE 210 and may not separately select sub-bands and RISs 260. Process 600 can also include base station 222 configuring the one or more RISs 260 and the one or more sub-bands (block 630) and notifying UE 210 of RISs 260, sub-bands, and corresponding configurations (block 635). Referring to Alt. B, in some implementations process 600 can include UE 210 configuring RISs 260 and sub-bands (block 640).

One or more of the techniques described with respect to FIG. 6 can apply to RIS-aided multiple input multiple output (MIMO) systems. The extension to RIS-aided MIMO systems based can be based on dual-polarization systems. For example, channels for data streams can be transmitted in different transmission polarization can be different. This can affect the SNR values, such as the SNR values calculated by UE 210 or base station 222. The sum of the SNR statistics of both transmission polarization (H and V) can be used for RIS selection and sub-band selection. The arithmetic sum can be represented by the following.

$${SNR}_{sum} = ( {SNR}_{H} + {SNR}_{V} ) / 2$$

The log mean (in db) of the SNR can be represented by the following.

$${SNR}_{sum}^{dB} = ( {SNR}_{H}^{dB} + {SNR}_{V}^{dB} ) / 2$$

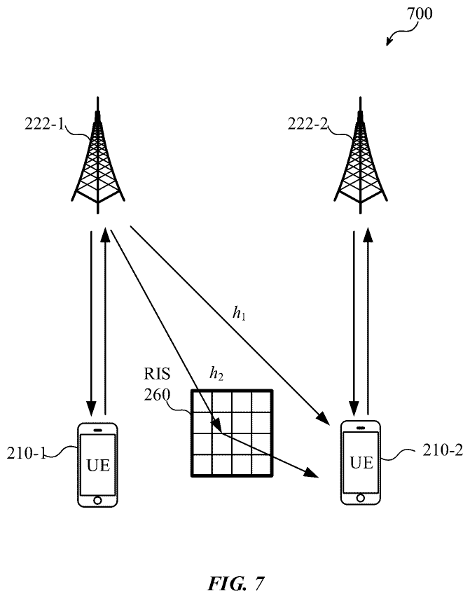

FIG. 7 is a diagram of an example 700 of selection of RISs 260 according to one or more implementations described herein. Process 700 describes interference management via RIS selection. With accurate sub-band channel estimation, the best RIS can be selected for minimal interference. For example, it can be assumed that two neighboring cells, such as base station 222-1 and base station 222-2 have scheduled transmissions on the same sub-band. The SNR on the interference sub-band is proportional to |h₁+h₂|², and Interference is completely cancelled when h₂=−h₁.

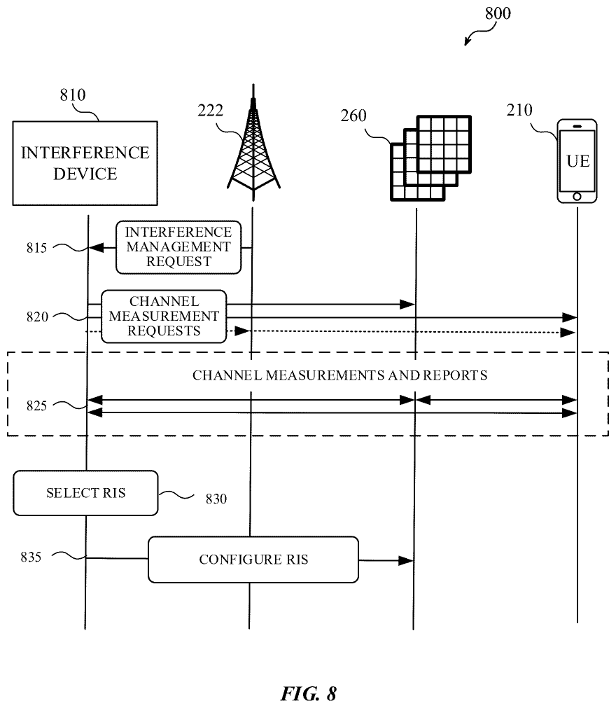

FIG. 8 is a diagram of an example 800 of selection of RISs 260 according to one or more implementations described herein. FIG. 8 is a diagram of an example process for RIS selection according to one or more implementations described herein. Process 800 can be implemented by UE 210, base station 222, one or more RISs 260, and interference device 810. In some implementations, some or all of process 800 can be performed by one or more other systems or devices, including one or more of the devices of FIG. 2. Additionally, process 800 can include one or more fewer, additional, differently ordered and/or arranged operations than those shown in FIG. 8. In some implementations, some or all of the operations of process 800 can be performed independently, successively, simultaneously, etc., of one or more of the other operations of process 800. Operations described below as being performed by a single base station can be performed by multiple base stations 222. Similarly, operations described below as being performed by a single RIS 260 can be performed by multiple RISs 260. As such, the techniques described herein are not limited to a number, sequence, arrangement, timing, etc., of the operations or processes depicted in FIG. 8. The interference device 810 can be a base station 222, a UE 210, or another device.

For purposes of explaining example process 800, base station 222 can send and receive signals directly from UE 210 (see, e.g., base station 222-2 and UE 210 of FIG. 7). For purposes of interference management as described by FIG. 8, in some scenarios base station 222 can be a transmitting device and UE 210 can be a receiving device; in other scenarios, UE 210 can be a transmitting device and base station 222 can be a receiving device. Operations described as being performed by base station 222 can be performed by UE 210; and operations described as being performed by UE 210 can be performed by base station 222. Interference device 810 can be another base station 222 (e.g., base station 222-1 of FIG. 7), another UE 210, and/or another type of transmission and reception device. Interference device 810 can send and receive signals directly from UE 210 and can send and receive signals indirectly from UE 210 via one or more RIS 260 (see, e.g., RIS 260 of FIG. 7). Interference device 810 and a transmitting device (e.g., base station 222) can be configured to communicate with a receiving device (e.g., UE 210) using the same sub-band or nearby sub-bands.

Process 800 can include base station 222 sending a request for interference management to interference device 810 (block 815). Base station 222 can share a transmission and reception schedule with interference device 810. The transmission and reception schedule can include time and frequency resources for transmissions between a transiting device (e.g., base station 222) and a receiving device (e.g., UE 210). The transmission and reception schedule can enable interference device 810 to later send signals to a receiving device (e.g., UE 210) for interference measurement. In some examples, UE 210, and/or another device, can transmit a request for interference management to interference device 810. In some examples, UE 210, and/or another device, can share a transmission and reception schedule with interference device 810.

Process 800 can include interference device 810 sending a channel measurement request to base station 222, RIS 260, and/or UE 210 (block 820). The channel measurement request can be sent directly to base station 222, RISs 260, and UE 210. In some examples, one device (e.g., base station 222) can forward a channel measurement request to another device (e.g., UE 210). The request can include resource allocation information (e.g., time and frequency resources) for signaling and performing channel measurements.

While not shown, interference device 810 can generate and communicate configuration information to RIS 260 for relaying communications from interference device 810 to the receiving device (e.g., UE 210). RIS 260 can receive and implement the configuration information. Interference device 810 can generate the configuration information based on the request for interference management and the transmission and reception schedule. In some implementations, the configuration information can be included in the channel measurement request sent to RIS 260. In some implementations, the configuration information can be sent via another communication.

Process 800 can include interference device 810 transmitting one or more signals to UE 210 directly and one or more other signals to UE 210 indirectly via RIS 260 (block 825). Interference device 810 can do so in accordance with transmission, resource, and/or scheduling information provided to UE 210 via a channel measurement request. The direct signal to UE 210 can be referred to as an interferer-Rx path. The indirect signal to UE 210 can be referred to as an interferer-RIS-Rx path. UE 210 can perform measurements on the direct and indirect signals from interference device 810 signals. UE 210 can generate one or more quality or performance metrics based on the measurements. Examples of the quality or performance metrics can include a sub-band SNR, path loss, RSRP, TDOA, delay difference estimation, etc. UE 210 can report the measurements and/or quality or performance metrics to interference device 810. UE 210 can report the measurements and/or quality or performance metrics to interference device 810 directly, via base station 222, and/or via RIS 260. In some implementations, interference device 810 may not be configured to select and/or configure RIS 260. In such scenarios, UE 210 can report the measurements and/or quality or performance metrics to a device (e.g., base station 222) configured to select and configure RIS 260.

UE 210, and/or base station 222 can measure the channel of the interference-BS path and the interference-RIS-BS path (block 805). The measurements can include sub-band SNR, path loss, RSRP, RODA, and delay difference estimation. UE 210 can report channel measurements to the interference device or to base station 222. Each device can report the measurements to the node responsible for RIS selection. For example, if the interference device 810 is responsible for RIS selection, UE 210 and base station 222 can report measurements to the interference device 810. If base station 222 is responsible for RIS selection, UE 210 and the interference device 810 can report measurements to base station 222.

Process 800 can include interference device 810 selecting one or more RISs 260 (block 830). Interference device 810 can select RIS 260 based on the measurements and/or quality or performance metrics from UE 210 and/or RIS 260. In some implementations, interference device 810 can select RIS(s) 260 that minimize, or reduce below a pre-selected threshold, the interference (e.g., RSRP on the scheduled sub-band (e.g., the sub-band also used by base station 222 to communicate with UE 210). In some implementations, interference device 810 can select a RIS 260 based on one or more additional, alternative, and/or different rules, thresholds, and/or criteria. Different rules, thresholds, and/or criteria can be applied to different types of measurements and/or quality or performance metrics. Different rules, thresholds, and/or criteria can also, or alternatively, be applied based whether one or multiple RIS 260 are to be selected, whether selection is among a threshold quantity of RISs 260, etc. Thresholds that can be applied can include SNR ratio thresholds of each sub-band, a path loss threshold, RSRP thresholds, channel capacity thresholds, or a combination thereof.

In some implementations, UE 210, base station 222, or another device can select a RIS 260 for communications between interference device 810 and a receiving device (e.g., UE 210). In such implementations, the device that selects RIS 260 can notify interference device 810 and/or UE 210 of the selected RIS 260.

The selection can be done by interference device 810, base station 222, or UE 210. The criteria can be generalized to select multiple RISs 260 simultaneously. Interference device 810 can configure the selected RISs 260 for interference cancellation. Interference device 810 can select multiple RISs 260, or a subset of the possible candidate RISs 260, to minimize the all overall interference on the scheduled sub-band. Interference on the scheduled sub-band can be calculated by combining channel measurements as indicated by the following.

$$Interference = {\vert {h}_{1} + {\sum }_{{m}_{i}} h ( {m}_{i} ) \vert}^{2}$$

The expression h(mᵢ) can represent the channel of Interferer-RIS(mᵢ)-receiver (e.g., UE 210).

Process 800 can include interference device 810 communicating configuration information to one or more RISs 260 (block 835). For example, interference device 810 can generate information for configuring one or more selected RISs 260. The configuration information can include instructions and parameters to relay signals between interference device 810 and UE 210 according to specified times, frequencies, bands, sub-bands, channels, conditions, constraints, etc. Interference device 810 can send the configuration information to the selected RISs 260. When multiple RISs 260 are selected, configuration information may be generated and communicated on a RIS-specific basis, such that each RIS 260 receives configuration information specific to the receiving RIS 260. In some implementations, each RIS 260 can receive the same configuration information and implement the configuration information associated with the receiving RIS 260. In some implementations (e.g., when many RISs 260 have been selected) interference device 810 can arrange and communicate configuration information according to RIS sub-groups, subsets, or batches.

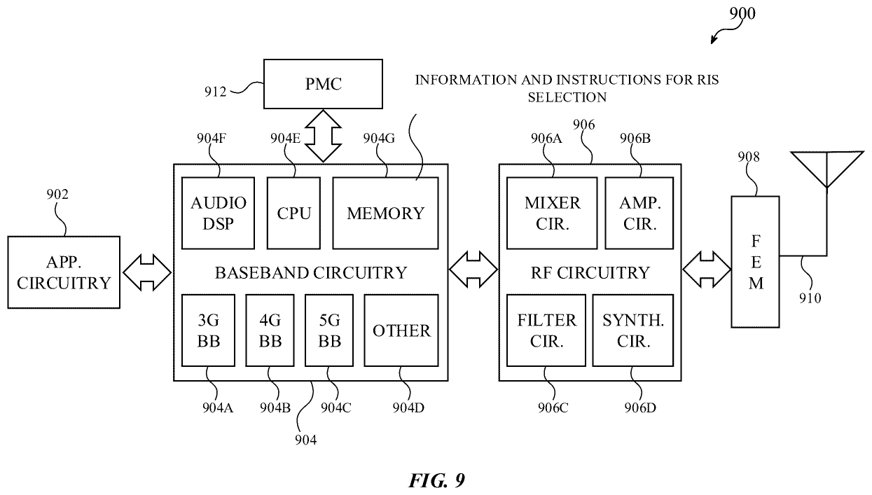

FIG. 9 is a diagram of an example of components of a device according to one or more implementations described herein. In some implementations, the device 900 can include application circuitry 902, baseband circuitry 904, RF circuitry 906, front-end module (FEM) circuitry 908, one or more antennas 910, and power management circuitry (PMC) 912 coupled together at least as shown. The components of the illustrated device 900 can be included in a UE or a RAN node. In some implementations, the device 900 can include fewer elements (e.g., a RAN node may not utilize application circuitry 902, and instead include a processor/controller to process IP data received from a CN or an Evolved Packet Core (EPC)). In some implementations, the device 900 can include additional elements such as, for example, memory/storage, display, camera, sensor (including one or more temperature sensors, such as a single temperature sensor, a plurality of temperature sensors at different locations in device 900, etc.), or input/output (I/O) interface. In other implementations, the components described below can be included in more than one device (e.g., said circuitries can be separately included in more than one device for Cloud-RAN (C-RAN) implementations).

The application circuitry 902 can include one or more application processors. For example, the application circuitry 902 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 900. In some implementations, processors of application circuitry 902 can process IP data packets received from an EPC.

The baseband circuitry 904 can include circuitry such as, but not limited to, one or more single-core or multi-core processors. The baseband circuitry 904 can include one or more baseband processors or control logic to process baseband signals received from a receive signal path of the RF circuitry 906 and to generate baseband signals for a transmit signal path of the RF circuitry 906. Baseband circuitry 904 can interface with the application circuitry 902 for generation and processing of the baseband signals and for controlling operations of the RF circuitry 906. For example, in some implementations, the baseband circuitry 904 can include a 3G baseband processor 904A, a 4G baseband processor 904B, a 5G baseband processor 904C, or other baseband processor(s) 904D for other existing generations, generations in development or to be developed in the future (e.g., 5G, 6G, etc.). The baseband circuitry 904 (e.g., one or more of baseband processors 904A-D) can handle various radio control functions that enable communication with one or more radio networks via the RF circuitry 906. In other implementations, some or all of the functionality of baseband processors 904A-D can be included in modules stored in the memory 904G and executed via a Central Processing Unit (CPU) 904E. The radio control functions can include, but are not limited to, signal modulation/demodulation, encoding/decoding, radio frequency shifting, etc. In some implementations, modulation/demodulation circuitry of the baseband circuitry 904 can include Fast-Fourier Transform (FFT), precoding, or constellation mapping/de-mapping functionality. In some implementations, encoding/decoding circuitry of the baseband circuitry 904 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 904G can receive and/or store information and instructions for enabling UE 210, and/or one or more components thereof, to engage in selection of one or more RISs 260. For example, the information and instructions can cause and/or enable UE 210 to receive RIS selection information from base station 222. The information and instructions can cause and/or enable UE 210 to determine, based on the RIS selection information and additional constraints, such as measurements performed by UE 210, a recommendation of one or more RISs 260. The information and instructions can also cause and/or enable UE 210 to transmit the recommendation to base station 222 and receive configuration or notification regarding the selected RISs 260. The information and instructions can also cause or enable UE 210, base station 222, and/or RIS 260 to perform one or more additional, alternative, or different operations described herein.

In some implementations, the baseband circuitry 904 can include one or more audio digital signal processor(s) (DSP) 904F. The audio DSPs 904F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 904 and the application circuitry 902 can be implemented together such as, for example, on a system on a chip (SOC).

In some implementations, the baseband circuitry 904 can provide for communication compatible with one or more radio technologies. For example, in some implementations, the baseband circuitry 904 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 904 is configured to support radio communications of more than one wireless protocol can be referred to as multi-mode baseband circuitry.

RF circuitry 906 can enable communication with wireless networks using modulated electromagnetic radiation through a non-solid medium. In various implementations, the RF circuitry 906 can include switches, filters, amplifiers, etc. to facilitate the communication with the wireless network. RF circuitry 906 can include a receive signal path which can include circuitry to down-convert RF signals received from the FEM circuitry 908 and provide baseband signals to the baseband circuitry 904. RF circuitry 906 can also include a transmit signal path which can include circuitry to up-convert baseband signals provided by the baseband circuitry 904 and provide RF output signals to the FEM circuitry 908 for transmission.

In some implementations, the receive signal path of the RF circuitry 906 can include mixer circuitry 906A, amplifier circuitry 906B and filter circuitry 906C. In some implementations, the transmit signal path of the RF circuitry 906 can include filter circuitry 906C and mixer circuitry 906A. RF circuitry 906 can also include synthesizer circuitry 906D for synthesizing a frequency for use by the mixer circuitry 906A of the receive signal path and the transmit signal path. In some implementations, the mixer circuitry 906A of the receive signal path can be configured to down-convert RF signals received from the FEM circuitry 908 based on the synthesized frequency provided by synthesizer circuitry 906D. The amplifier circuitry 906B can be configured to amplify the down-converted signals and the filter circuitry 906C can be a low-pass filter (LPF) or band-pass filter (BPF) configured to remove unwanted signals from the down-converted signals to generate output baseband signals. Output baseband signals can be provided to the baseband circuitry 9404 for further processing. In some implementations, the output baseband signals can be zero-frequency baseband signals, although this is not a requirement. In some implementations, mixer circuitry 906A of the receive signal path can comprise passive mixers, although the scope of the implementations is not limited in this respect.

In some implementations, the mixer circuitry 906A of the transmit signal path can be configured to up-convert input baseband signals based on the synthesized frequency provided by the synthesizer circuitry 906D to generate RF output signals for the FEM circuitry 908. The baseband signals can be provided by the baseband circuitry 904 and can be filtered by filter circuitry 906C.

In some implementations, the mixer circuitry 06A of the receive signal path and the mixer circuitry 1906A of the transmit signal path can include two or more mixers and can be arranged for quadrature down conversion and up conversion, respectively. In some implementations, the mixer circuitry 906A of the receive signal path and the mixer circuitry 906A of the transmit signal path can include two or more mixers and can be arranged for image rejection (e.g., Hartley image rejection). In some implementations, the mixer circuitry 06A of the receive signal path and the mixer circuitry '906A can be arranged for direct down conversion and direct up conversion, respectively. In some implementations, the mixer circuitry 9069 of the receive signal path and the mixer circuitry 906A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 906 can include analog-to-digital converter (ADC) and digital-to-analog converter (DAC) circuitry and the baseband circuitry 904 can include a digital baseband interface to communicate with the RF circuitry 906.

In some dual-mode implementations, a separate radio IC circuitry can be provided for processing signals for each spectrum, although the scope of the implementations is not limited in this respect.

In some implementations, the synthesizer circuitry 906D can be a fractional-N synthesizer or a fractional N/N+1 synthesizer, although the scope of the implementations is not limited in this respect as other types of frequency synthesizers can be suitable. For example, synthesizer circuitry 906D can be a delta-sigma synthesizer, a frequency multiplier, or a synthesizer comprising a phase-locked loop with a frequency divider.

The synthesizer circuitry 906D can be configured to synthesize an output frequency for use by the mixer circuitry 906A of the RF circuitry 906 based on a frequency input and a divider control input. In some implementations, the synthesizer circuitry 906D can be a fractional N/N+1 synthesizer.

In some implementations, frequency input can be provided by a voltage-controlled oscillator (VCO), although that is not a requirement. Divider control input can be provided by either the baseband circuitry 904 or the applications circuitry 902 depending on the desired output frequency. In some implementations, a divider control input (e.g., N) can be determined from a look-up table based on a channel indicated by the applications circuitry 902.

Synthesizer circuitry 906D of the RF circuitry 906 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 906D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 906 can include an IQ/polar converter.

FEM circuitry 908 can include a receive signal path which can include circuitry configured to operate on RF signals received from one or more antennas 910, amplify the received signals and provide the amplified versions of the received signals to the RF circuitry 906 for further processing. FEM circuitry 908 can also include a transmit signal path which can include circuitry configured to amplify signals for transmission provided by the RF circuitry 906 for transmission by one or more of the one or more antennas 910. In various implementations, the amplification through the transmit or receive signal paths can be done solely in the RF circuitry 906, solely in the FEM circuitry 908, or in both the RF circuitry 906 and the FEM circuitry 908.

In some implementations, the FEM circuitry 908 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 906). The transmit signal path of the FEM circuitry 908 can include a power amplifier (PA) to amplify input RF signals (e.g., provided by RF circuitry 906), and one or more filters to generate RF signals for subsequent transmission (e.g., by one or more of the one or more antennas 910).

In some implementations, the PMC 912 can manage power provided to the baseband circuitry 904. In particular, the PMC 912 can control power-source selection, voltage scaling, battery charging, or DC-to-DC conversion. The PMC 912 can often be included when the device 900 is capable of being powered by a battery, for example, when the device is included in a UE. The PMC 912 can increase the power conversion efficiency while providing desirable implementation size and heat dissipation characteristics.

While FIG. 9 shows the PMC 912 coupled only with the baseband circuitry 904. However, in other implementations, the PMC 912 can be additionally or alternatively coupled with, and perform similar power management operations for, other components such as, but not limited to, application circuitry 902, RF circuitry 906, or FEM circuitry 908.

In some implementations, the PMC 912 can control, or otherwise be part of, various power saving mechanisms of the device 900. For example, if the device 900 is in an RRC_Connected state, where it is still connected to the RAN node as it expects to receive traffic shortly, then it can enter a state known as Discontinuous Reception Mode (DRX) after a period of inactivity. During this state, the device 900 can power down for brief intervals of time and thus save power.

If there is no data traffic activity for an extended period of time, then the device 900 can transition off to an RRC_Idle state, where it disconnects from the network and does not perform operations such as channel quality feedback, handover, etc. The device 900 goes into a very low power state and it performs paging where again it periodically wakes up to listen to the network and then powers down again. The device 900 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 902 and processors of the baseband circuitry 904 can be used to execute elements of one or more instances of a protocol stack. For example, processors of the baseband circuitry 904, alone or in combination, can be used execute Layer 3, Layer 2, or Layer 1 functionality, while processors of the baseband circuitry 904 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

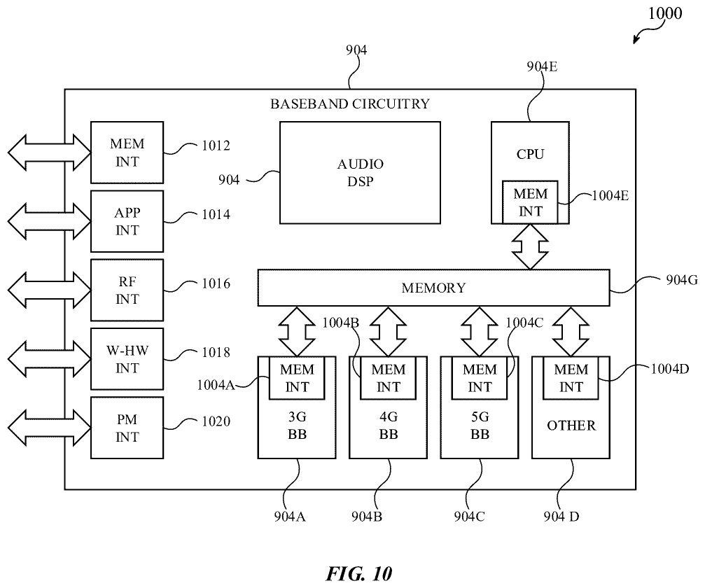

FIG. 10 is a diagram of example interfaces 1000 of baseband circuitry according to one or more implementations described herein. As discussed above, the baseband circuitry 904 of FIG. 9 can comprise processors 904A through 904E and a memory 904G utilized by said processors. Each of the processors 904A through 904E can include a memory interface, 1040A through 1040E, respectively, to send/receive data to/from the memory 904G.

In some implementations, memory 904G can receive, store, and/or provide information and instructions for RIS selection. For example, base station 222 can communicate RIS selection information to UE 210, and UE 210 can select one or more RISs 260 based on the RIS selection information and/or additional criteria. UE 210 can indicate the selected RISs 260 to base station 222, and base station 222 can select one or more RISs 260. Base station 222 can also, or alternatively, configure one or more RISs 260 for communications between base station 222 and UE 210. The information and instructions can also cause or enable UE 210, base station 222, and/or RIS 260 to perform one or more additional, alternative, or different operations described herein.

The baseband circuitry 904 can further include one or more interfaces to communicatively couple to other circuitries/devices, such as a memory interface 952 (e.g., an interface to send/receive data to/from memory external to the baseband circuitry 904), an application circuitry interface 1014 (e.g., an interface to send/receive data to/from the application circuitry 902 of FIG. 9), an RF circuitry interface 1016 (e.g., an interface to send/receive data to/from RF circuitry 906 of FIG. 9), a wireless hardware connectivity interface 1018 (e.g., an interface to send/receive data to/from Near Field Communication (NFC) components, Bluetooth® components (e.g., Bluetooth® Low Energy), Wi-Fi® components, and other communication components), and a power management interface 1020 (e.g., an interface to send/receive power or control signals to/from the PMC 912).

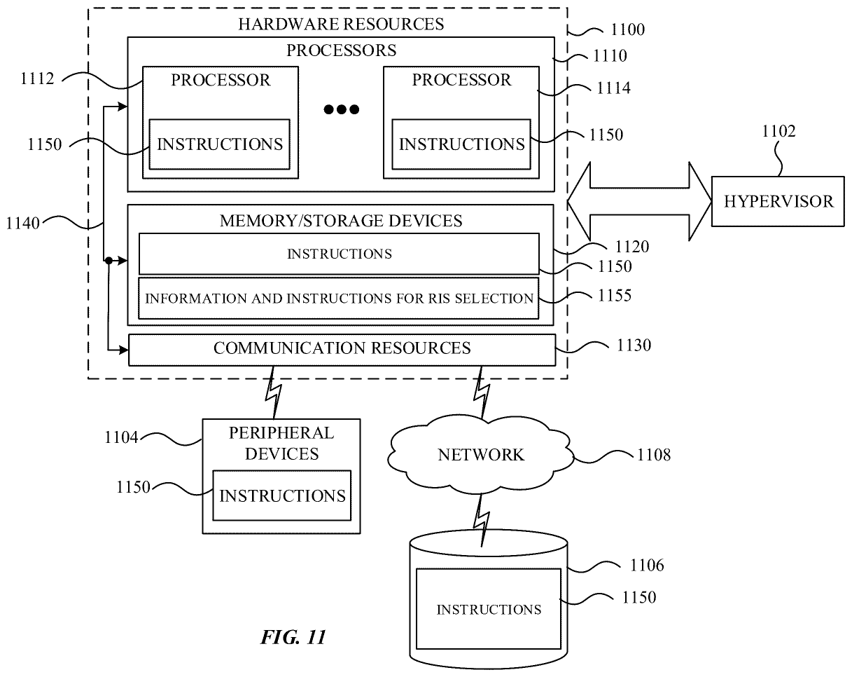

FIG. 11 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors (or processor cores) 1110, one or more memory/storage devices 1110, and one or more communication resources 1130, each of which can be communicatively coupled via a bus 1140. For implementations where node virtualization (e.g., NFV) is utilized, a hypervisor can be executed to provide an execution environment for one or more network slices/sub-slices to utilize the hardware resources 1100. The hardware resources 1100 may interact with the hypervisor 1102. For example, the hypervisor 1102 can schedule or otherwise manage the hardware resource 1100.

The processors 1110 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 1112 and a processor 1114.

The memory/storage devices 1110 can include main memory, disk storage, or any suitable combination thereof. The memory/storage devices 1110 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1110 receive and/or store information and instructions 1155 for RIS selection. The base station can communicate RIS selection information to the UE, and the UE can select one or more RISs based on the RIS selection information and additional criteria. The UE can indicate the selected RISs to the base station, and the base station can select one or more RISs. The base station can configure the one or more RISs. These and many other features and examples are discussed herein.

The communication resources 1130 can include interconnection or network interface components or other suitable devices to communicate with one or more peripheral devices 1104 or one or more databases 1106 via a network 1108. For example, the communication resources 1130 can include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1150 can comprise software, a program, an application, an applet, an app, or other executable code for causing at least any of the processors 1110 to perform any one or more of the methodologies discussed herein. The instructions 1150 can reside, completely or partially, within at least one of the processors 1110 (e.g., within the processor's cache memory), the memory/storage devices 1110, or any suitable combination thereof. Furthermore, any portion of the instructions 1150 can be transferred to the hardware resources 1100 from any combination of the peripheral devices 1104 or the databases 1106. Accordingly, the memory of processors 1110, the memory/storage devices 1110, the peripheral devices 1104, and the databases 1106 are examples of computer-readable and machine-readable media.

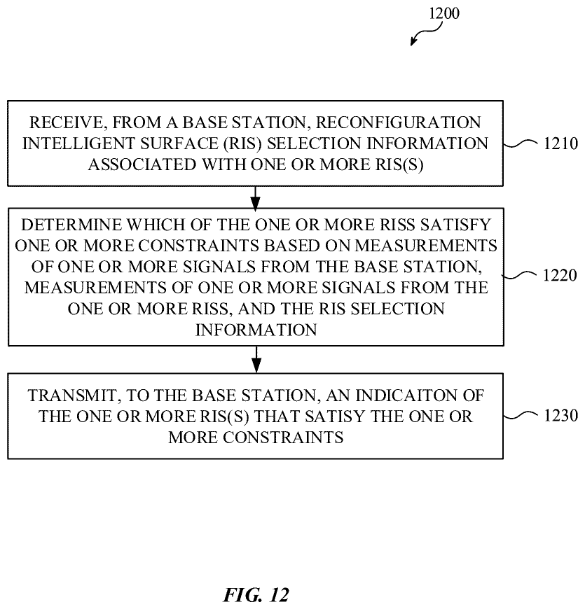

FIG. 12 is a diagram of an example process for selection of RISs 260 according to one or more implementations described herein. Process 1200 can be implemented by UE 210. In some implementations, some or all of process 1200 can be performed by one or more other systems or devices, including one or more of the devices of FIG. 2. Additionally, process 1200 can include one or more fewer, additional, differently ordered and/or arranged operations than those shown in FIG. 12. In some implementations, some or all of the operations of process 1200 can be performed independently, successively, simultaneously, etc., of one or more of the other operations of process 1200. As such, the techniques described herein are not limited to a number, sequence, arrangement, timing, etc., of the operations or processes depicted in FIG. 12.

Process 1200 can include receiving, from a base station, RIS selection information associated with one or more RISs (block 1210). Process 1200 can include determining which of one or more RISs 260 satisfy one or more constraints based on measurements of one or more signals from base station 222, measurements of one or more signals from one or more RISs 260, and the RIS selection information (block 1220). Process 1200 can include transmitting, to base station 222, an indication of one or more RISs 260 that satisfy the one or more constraints (block 1230).

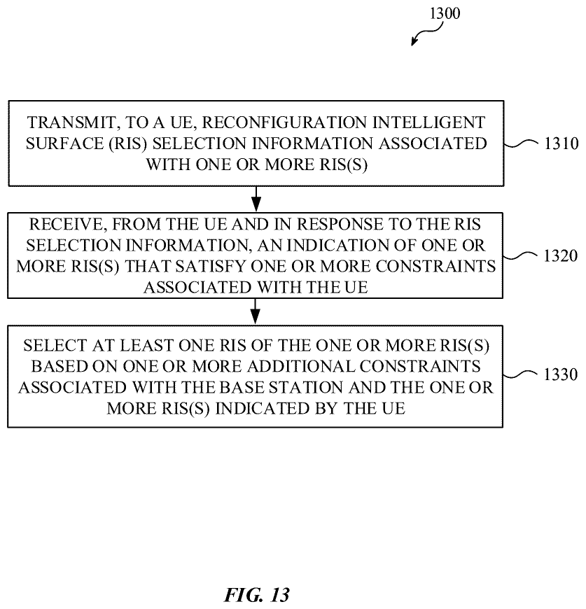

FIG. 13 is a diagram of an example process for selection of RISs 260 according to one or more implementations described herein. Process 1300 can be implemented by base station 222. In some implementations, some or all of process 1300 can be performed by one or more other systems or devices, including one or more of the devices of FIG. 2. Additionally, process 1300 can include one or more fewer, additional, differently ordered and/or arranged operations than those shown in FIG. 13. In some implementations, some or all of the operations of process 1300 can be performed independently, successively, simultaneously, etc., of one or more of the other operations of process 1300. As such, the techniques described herein are not limited to a number, sequence, arrangement, timing, etc., of the operations or processes depicted in FIG. 13.

Process 1300 can include transmitting, to UE 210, RIS selection information associated with one or more RISs 260 (block 1310). Process 1300 can include receiving, from UE 210 and in response to the RIS selection information, an indication of one or more RISs 260 that satisfy one or more constraints associated with UE 210 (block 1230). Process 1300 can include selecting at least one RIS of one or more RISs 260 based on one or more additional constraints associated with base station 222 and one or more RISs 260 indicated by UE 210 (block 1330).

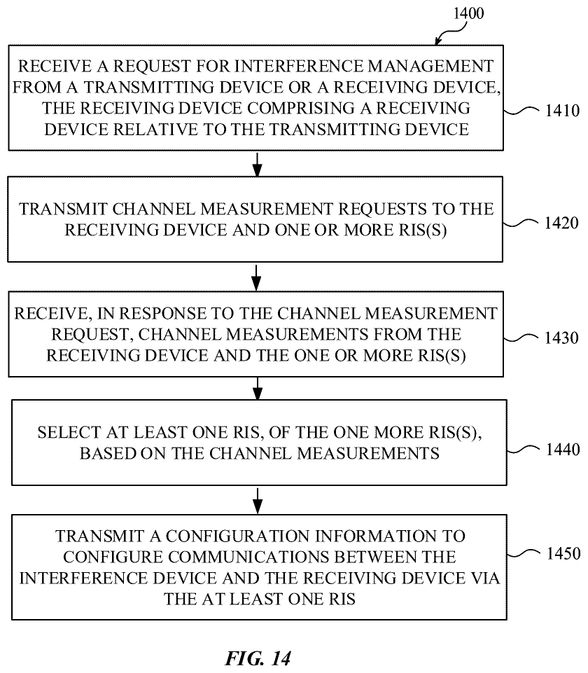

FIG. 14 is a diagram of an example process for selection of RISs 260 according to one or more implementations described herein. Process 1400 can be implemented by interference device 810. In some implementations, some or all of process 1400 can be performed by one or more other systems or devices, including one or more of the devices of FIG. 2. Additionally, process 1400 can include one or more fewer, additional, differently ordered and/or arranged operations than those shown in FIG. 14. In some implementations, some or all of the operations of process 1400 can be performed independently, successively, simultaneously, etc., of one or more of the other operations of process 1400. As such, the techniques described herein are not limited to a number, sequence, arrangement, timing, etc., of the operations or processes depicted in FIG. 14.

Process 1400 can include receiving a request for interference management from a transmitting device or a receiving device, the receiving device including a receiving device relative to the transmitting device (block 1410). Process 1400 can include transmitting channel measurement requests to the receiving device and one or more RISs 260 (block 1420). Process 1400 can include receiving, in response to the channel measurement request, channel measurements from the receiving device and one or more RISs 260 (block 1430). Process 1400 can include selecting at least one RIS 260, of one or more RISs 260, based on the channel measurements (block 1440). Process 1400 can include transmitting a configuration information to configure communications between the interference device and the receiving device via at least one RIS 260 (block 1450).

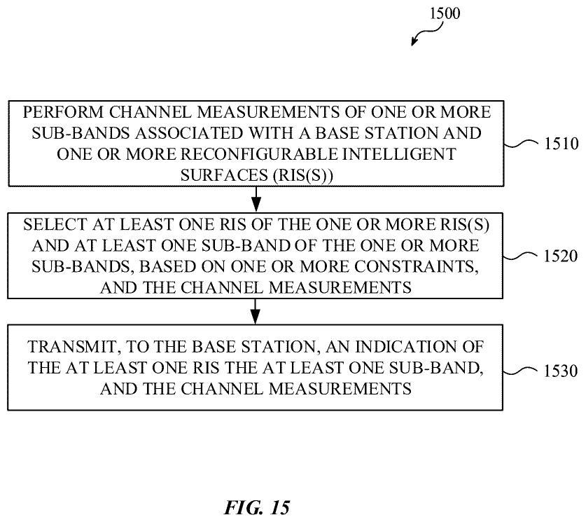

FIG. 15 is a diagram of an example process for selection RISs 260 according to one or more implementations described herein. Process 1500 can be implemented by base station 222. In some implementations, some or all of process 1500 can be performed by one or more other systems or devices, including one or more of the devices of FIG. 2. Additionally, process 1500 can include one or more fewer, additional, differently ordered and/or arranged operations than those shown in FIG. 15. In some implementations, some or all of the operations of process 1500 can be performed independently, successively, simultaneously, etc., of one or more of the other operations of process 1600. As such, the techniques described herein are not limited to a number, sequence, arrangement, timing, etc., of the operations or processes depicted in FIG. 15.

Process 1500 can include performing channel measurements of one or more sub-bands associated with a base station and one or more RISs 260 (block 1510). Process 1500 can select at least one RIS of one or more RISs 260 and at least one sub-band of the one or more sub-bands, based on one or more constraints, and the channel measurements (block 1520). Process 1500 can include transmitting, to base station 222, an indication of at least one RIS 260, the at least one sub-band, and the channel measurements (block 1530).

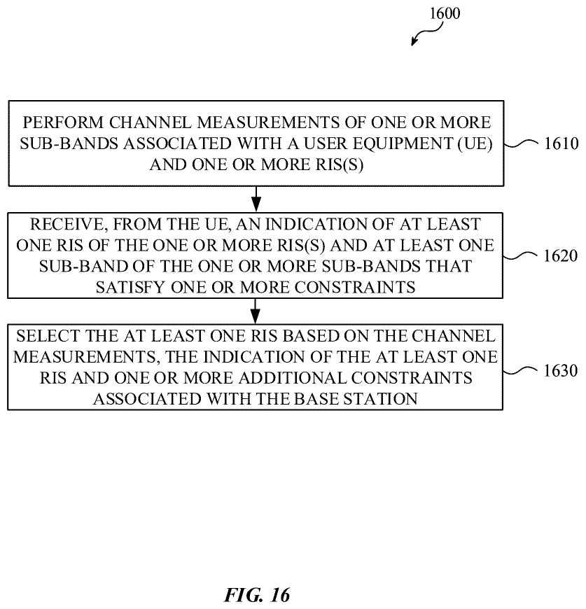

FIG. 16 is a diagram of an example process for selection RISs 260 according to one or more implementations described herein. Process 1600 can be implemented by base station 222. In some implementations, some or all of process 1600 can be performed by one or more other systems or devices, including one or more of the devices of FIG. 2. Additionally, process 1600 can include one or more fewer, additional, differently ordered and/or arranged operations than those shown in FIG. 16. In some implementations, some or all of the operations of process 1600 can be performed independently, successively, simultaneously, etc., of one or more of the other operations of process 1600. As such, the techniques described herein are not limited to a number, sequence, arrangement, timing, etc., of the operations or processes depicted in FIG. 16.

Process 1600 can include performing channel measurements of one or more sub-bands associated with UE 210 and one or more RISs 260 (block 1610). Process 1600 can include receiving, from UE 210, an indication of at least one RIS of one or more RISs 260 and at least one sub-band of the one or more sub-bands that satisfy one or more constraints (block 1620). Process 1600 can include selecting at least one RIS 260 based on the channel measurements, the indication of at least one RIS 260 and one or more additional constraints associated with the base station 222 (block 1630).

Examples and/or implementations herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which can also include one or more of the examples described herein, a UE can comprise: a memory; and one or more processors configured to, when executing instructions stored in the memory, cause the UE to: receive, from a base station, reconfiguration intelligent surface (RIS) selection information associated with one or more RISs; determine which of the one or more RISs satisfy one or more constraints based on measurements of one or more signals from the base station, measurements of one or more signals from the one or more RISs, and the RIS selection information; and transmit, to the base station, an indication of the one or more RISs that satisfy the one or more constraints.

In example 2, which can also include one or more of the examples described herein, the one or more processors are configured to cause the UE to: receive, from the base station and in response to the indication of the one or more RISs that satisfy the one or more constraints, configuration information associated with communicating with the at least one RIS selected by the base station.

In example 3, which can also include one or more of the examples described herein, the one or more processors are configured to cause the UE to: transmit, to the one or more RISs that satisfy the one or more constraints, communication configuration information to configure the one or more RISs for communications between the UE and the base station via the one or more RISs.

In example 4, which can also include one or more of the examples described herein, the one or more processors are configured to cause the UE to: perform the measurements, where the measurements comprise: a signal-to-noise ratio of one or more signals from the base station to the UE via an RIS of the one or more RISs, a signal to noise ratio of one or more signals from the base station to the UE, a path delay of a path from the base station to the UE via the RIS of the one or more RISs, an angle of arrival and an angle of departure corresponding to the RIS of the one or more RISs in relation to the base station, an illumination corresponding to the RIS of the one or more RISs, or a combination thereof.

In example 5, which can also include one or more of the examples described herein, the RIS selection information is received in response to transmitting a request to the base station for the RIS selection information.

In example 6, which can also include one or more of the examples described herein, the RIS selection information is received as part of a periodic transmission of the RIS selection information by the base station.

In example 7, which can also include one or more of the examples described herein, the RIS selection information further comprises: one or more widths of one or more beams associated with the base station, one or more time and frequency resources associated with the one or more RISs, authentication information associated with the one or more RISs, power consumption of the one or more RISs, or a combination thereof.

In example 8, which can also include one or more of the examples described herein, the RIS selection information further comprises: network map information, a geographic location of the one or more RISs, capabilities of the one or more RISs, or a combination thereof.

In example 9, which can also include one or more of the examples described herein, the one or more constraints comprise one or more thresholds, and the one or more thresholds comprise: a path delay threshold, a path loss threshold, a signal-to-noise ration threshold, an outage threshold, or a combination thereof.

In example 10, which can also include one or more of the examples described herein, the indication of the one or more RISs comprises a RIS recommended for selection by the base station.

In example 11, which can also include one or more of the examples described herein, the one or more processors are configured to cause the UE to: receive the one or more signals from the base station and the one or more signals from the one or more RISs; and perform at least one measurement associated with the one or more signals from the base station and the one or more signals from the one or more RISs.

In example 12, which can also include one or more of the examples described herein, a base station can comprise, a memory; and one or more processors configured to, when executing instructions stored in the memory, cause the base station to: transmit, to a UE, RIS selection information associated with one or more RISs; receive, from the UE and in response to the RIS selection information, an indication of one or more RISs that satisfy one or more constraints associated with the UE; and select at least one RIS of the one or more RISs based on one or more additional constraints associated with the base station and the one or more RISs indicated by the UE.

In example 13, which can also include one or more of the examples described herein, the one or more processors are configured to cause the base station to: transmit, to the UE, configuration information associated communicating with the at least one RIS selected by the base station.

In example 14, which can also include one or more of the examples described herein, the one or more processors are configured to cause the base station to transmit, to the at least one RIS selected by the base station, configuration information to configure the one or more RISs for communications between the UE and the base station via the one or more RISs.

In example 15, which can also include one or more of the examples described herein, the one or more additional constraints can comprise: a path from the base station to the UE, and a path from the base station to the UE via an RIS of the one or more RISs, is associated with one or more beams associated with the base station, an outage probability associated with each of the one or more RISs, resource parameters associated with the one or more RISs, authentication of the one or more RISs, a power consumption of one or more RISs, or a combination thereof.

In example 16, which can also include one or more of the examples described herein, the RIS selection information further comprises: one or more width of one or more beams associated with the base station, one or more resources associated with the one or more RISs, authentication information associated with the one or more RISs, power consumption of the one or more RISs, network information, or a combination thereof.

In example 17, which can also include one or more of the examples described herein, the RIS selection information further comprises: a geographic location of the one or more RISs, a capability of the one or more RISs; a path delay of a path from the base station to the UE via an RIS of the one or more RISs, an angle of arrival and an angle of departure corresponding to the RIS of the one or more RISs in relation to the base station, an illumination of the RIS of the one or more RISs, or a combination thereof.

In example 18, which can also include one or more of the examples described herein, the RIS selection information is transmitted in response to receiving a request from the UE for the RIS selection information.

In example 19, which can also include one or more of the examples described herein, the RIS selection information is transmitted as part of a periodic transmission of the RIS selection information.

In example 20, which can also include one or more of the examples described herein, base band circuitry may comprise a memory; and one or more processors configured to, when executing instructions stored in the memory, cause the baseband circuitry to: receive, via an interface with radio frequency circuitry, reconfiguration intelligent surface (RIS) selection information associated with one or more RISs; determine which of the one or more RISs satisfy one or more constraints based on measurements of one or more signals from the base station, measurements of one or more signals from the one or more RISs, and the RIS selection information; and transmit, to the interface with radio frequency circuitry, an indication of the one or more RISs that satisfy the one or more constraints.

In example 21, which can also include one or more of the examples described herein, the method, which can be implemented by a UE, further comprises: receiving, from a base station, reconfiguration intelligent surface (RIS) selection information associated with one or more RISs; determining which of the one or more RISs satisfy one or more constraints based on measurements of one or more signals from the base station, measurements of one or more signals from the one or more RISs, and the RIS selection information; and transmitting, to the base station, an indication of the one or more RISs that satisfy the one or more constraints.

In example 22, which can also include one or more of the examples described herein, the method, which can be implemented by a base station, further comprises: transmitting, to a UE, RIS selection information associated with one or more RISs; receiving, from the UE and in response to the RIS selection information, an indication of one or more RISs that satisfy one or more constraints associated with the UE; and selecting at least one RIS of the one or more RISs based on one or more additional constraints associated with the base station and the one or more RISs indicated by the UE.

In example 23, which can also include one or more of the examples described herein, the method, which can be implemented by baseband circuitry, further comprises: receiving, via an interface with radio frequency circuitry, RIS selection information associated with one or more RISs; determining which of the one or more RISs satisfy one or more constraints based on measurements of one or more signals from the base station, measurements of one or more signals from the one or more RISs, and the RIS selection information; and transmitting, to the interface with radio frequency circuitry, an indication of the one or more RISs that satisfy the one or more constraints.

In example 24, which can also include one or more of the examples described herein, an interference device can comprise: a memory; and one or more processors configured to, when executing instructions stored in the memory, cause the baseband circuitry to: receive a request for interference management from a transmitting device or a receiving device, the receiving device comprising a receiving device relative to the transmitting device; transmit channel measurement requests to the receiving device and one or more reconfiguration intelligent surfaces (RISs); receive, in response to the channel measurement request, channel measurements from the receiving device and the one or more RISs; select at least one RIS, of the one more RISs, based on the channel measurements; and transmit a configuration information to configure communications between the interference device and the receiving device via the at least one RIS.

In example 25, which can also include one or more of the examples described herein, the interference device is configured for a scheduled transmission to the UE using a same or overlapping sub-band as the transmitting device.

In example 26, which can also include one or more of the examples described herein, one or more processors are configured to cause the interference device to: transmit the channel measurement request to the receiving device indirectly via the transmitting device.

In example 27, which can also include one or more of the examples described herein, the channel measurement requests transmitted to the one or more RISs are relayed to the receiving device.

In example 28, which can also include one or more of the examples described herein, at least one channel measurement, of the one or more channel measurements, is received from the receiving device via the one or more RISs.

In example 29, which can also include one or more of the examples described herein, the interference device comprises a first base station, the transmitting device comprises a second base station, and the receiving device comprises a UE.

In example 30, which can also include one or more of the examples described herein, the channel measurements comprise: a signal-to-noise ratio associated with a sub-band used for direct signaling from the interference device to the receiving device, a signal-to-noise ratio associated with a sub-band used for indirect signaling from the interference device to the receiving device via the one or more RISs, a pathloss associated with direct signaling from the interference device to the receiving device, a pathloss associated with indirect signaling from the interference device to the receiving device via the one or more RISs, a reference signal received power associated with direct signaling from the interference device to the receiving device, a reference signal received power associated with indirect signaling from the interference device to the receiving device via the one or more RISs, a time difference of arrival associated with signaling directly from the interference device to the receiving device, and a time difference of arrival associated with indirect signaling from the interference device to the receiving device via the one or more RISs, a delay difference estimation associated with direct signaling from the interference device to the receiving device, a delay difference estimation associated with indirect signaling from the interference device to the receiving device via the one or more RISs, or a combination thereof.

In example 31, which can also include one or more of the examples described herein, a UE can comprise: a memory; and one or more processors configured to, when executing instructions stored in the memory, cause the UE to: perform channel measurements of one or more sub-bands associated with a base station and one or more reconfigurable intelligent surfaces (RISs); select at least one RIS of the one or more RISs and at least one sub-band of the one or more sub-bands, based on one or more constraints, and the channel measurements; and transmit, to the base station, an indication of the at least one RIS the at least one sub-band, and the channel measurements.

In example 32, which can also include one or more of the examples described herein, one or more processors are configured to cause the UE to: transmit the channel measurements to the base station via the at least one RIS of the one or more RISs.

In example 33, which can also include one or more of the examples described herein, one or more processors are configured to cause the UE to: receive, from the base station, configuration information associated with the at least one RIS and the at least one sub-band.

In example 34, which can also include one or more of the examples described herein, the channel measurements comprise: a signal-to-noise ratio of each sub-band of the one or more sub-bands, a sum of signal-to-noise ratios associated with transmission polarizations; a pathloss associated with direct signaling from the base station to the UE, a pathloss associated with indirect signaling from the base station to the UE via the one or more RISs, a reference signal received power associated with direct signaling from the base station to the UE; a reference signal received power associated with indirect signaling from the base station to the UE via the one or more RISs; a time difference of arrival associated with direct signaling from the base station to the UE; a time difference of arrival associated with indirect signaling from the base station to the UE; a delay difference estimation associated with direct signaling from the base station to the UE; a delay difference estimation associated with indirect signaling from the base station to the UE via the one or more RISs, or a combination thereof.

In example 35, which can also include one or more of the examples described herein, the one or more constraints comprise: a signal-to-noise ratio threshold of each sub-band, a path loss threshold, reference signal received power threshold; channel capacity threshold, or a combination thereof.

In example 36, which can also include one or more of the examples described herein, one or more processors are configured to cause the UE to: receive a channel measurement request from the base station or an interference device.

In example 37, which can also include one or more of the examples described herein, a base station can comprise: a memory; and one or more processors configured to, when executing instructions stored in the memory, cause the base station to: perform channel measurements of one or more sub-bands associated with a user equipment (UE) and one or more reconfigurable intelligent surfaces (RISs); receive, from the UE, an indication of at least one RIS of the one or more RISs and at least one sub-band of the one or more sub-bands that satisfy one or more constraints; and select the at least one RIS based on the channel measurements, the indication of the at least one RIS and one or more additional constraints associated with the base station.

In example 38, which can also include one or more of the examples described herein, one or more processors are configured to cause the base station to: transmit configuration information to configure the at least one RISs for communications between the base station and the UE via the at least one RIS; and transmit an indication to the UE of the at least one RIS being selected.

In example 39, which can also include one or more of the examples described herein, the channel measurements comprise: a signal-to-noise ratio of each sub-band of the one or more sub-bands, a sum of signal-to-noise ratios associated with transmission polarizations; a pathloss associated with direct signaling from the base station to the UE, a pathloss associated with indirect signaling from the base station to the UE via the one or more RISs, a reference signal received power associated with direct signaling from the base station to the UE, a reference signal received power associated with indirect signaling from the base station to the UE via the one or more RISs; a time difference of arrival associated with direct signaling from the base station to the UE; a time difference of arrival associated with indirect signaling from the base station to the UE; a delay difference estimation associated with direct signaling from the base station to the UE; a delay difference estimation associated with indirect signaling from the base station to the UE via the one or more RISs, or a combination thereof.

In example 40, which can also include one or more of the examples described herein, the one or more constraints comprise: a signal-to-noise ratio threshold of each sub-band, a path loss threshold, reference signal received power threshold; channel capacity threshold, or a combination thereof.

In example 41, which can also include one or more of the examples described herein, one or more processors are configured to cause the base station to: transmit a request for interference management to an interference device; receive, from the interference device a channel measurement request; and transmit one or more channel measurements to the interference device in response to the channel measurement request.

In example 42, which can also include one or more of the examples described herein, the method, which can be implemented by an interference device, further comprises: receiving a request for interference management from a transmitting device or a receiving device, the receiving device comprising a receiving device relative to the transmitting device; transmitting channel measurement requests to the receiving device and one or more RISs; receiving, in response to the channel measurement request, channel measurements from the receiving device and the one or more RISs; selecting at least one RIS, of the one more RISs, based on the channel measurements; and transmitting a configuration information to configure communications between the interference device and the receiving device via the at least one RIS.

In example 43, which can also include one or more of the examples described herein, the method, which can be implemented by a UE, further comprises: performing channel measurements of one or more sub-bands associated with a base station and one or more RISs; selecting at least one RIS of the one or more RISs and at least one sub-band of the one or more sub-bands, based on one or more constraints, and the channel measurements; and transmitting, to the base station, an indication of the at least one RIS the at least one sub-band, and the channel measurements.

In example 44, which can also include one or more of the examples described herein, the method, which can be implemented by a base station, further comprises: performing channel measurements of one or more sub-bands associated with a user equipment (UE) and one or more reconfigurable intelligent surfaces (RISs); receiving, from the UE, an indication of at least one RIS of the one or more RISs and at least one sub-band of the one or more sub-bands that satisfy one or more constraints; and selecting the at least one RIS based on the channel measurements, the indication of the at least one RIS and one or more additional constraints associated with the base station.

The examples discussed above also extend to method, computer-readable medium, and means-plus-function claims and implementations, an of which can include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. An interference device, comprising:
a memory; and
one or more processors configured to, when executing instructions stored in the memory, cause the baseband circuitry to:
receive a request for interference management from a transmitting device or a receiving device, the receiving device comprising a receiving device relative to the transmitting device;
transmit channel measurement requests to the receiving device and one or more reconfiguration intelligent surfaces (RISs);
receive, in response to the channel measurement request, channel measurements from the receiving device and the one or more RISs;
select at least one RIS, of the one more RISs, based on the channel measurements; and
transmit a configuration information to configure communications between the interference device and the receiving device via the at least one RIS.

2. The interference device of claim 1, wherein the interference device is configured for a scheduled transmission to the UE using a same or overlapping sub-band as the transmitting device.

3. The interference device of claim 1, wherein the one or more processors are further configured to cause the interference device to:
transmit the channel measurement request to the receiving device indirectly via the transmitting device.

4. The interference device of claim 1, wherein the channel measurement requests transmitted to the one or more RISs are relayed to the receiving device.

5. The interference device of claim 1, wherein at least one channel measurement, of the one or more channel measurements, is received from the receiving device via the one or more RISs.

6. The interference device of claim 1, wherein the interference device comprises a first base station, the transmitting device comprises a second base station, and the receiving device comprises a user equipment (UE).

7. The interference device of claim 1, wherein the channel measurements comprise:
a signal-to-noise ratio associated with a sub-band used for direct signaling from the interference device to the receiving device,
a signal-to-noise ratio associated with a sub-band used for indirect signaling from the interference device to the receiving device via the one or more RISs,
a pathloss associated with direct signaling from the interference device to the receiving device,
a pathloss associated with indirect signaling from the interference device to the receiving device via the one or more RISs,
a reference signal received power associated with direct signaling from the interference device to the receiving device,
a reference signal received power associated with indirect signaling from the interference device to the receiving device via the one or more RISs, or
a combination thereof.

8. The interference device of claim 1, wherein the channel measurements comprise:
a time difference of arrival associated with signaling directly from the interference device to the receiving device,
a time difference of arrival associated with indirect signaling from the interference device to the receiving device via the one or more RISs,
a delay difference estimation associated with direct signaling from the interference device to the receiving device,
a delay difference estimation associated with indirect signaling from the interference device to the receiving device via the one or more RISs, or
a combination thereof.

9. A user device (UE), comprising:
a memory; and
one or more processors configured to, when executing instructions stored in the memory, cause the UE to:
perform channel measurements of one or more sub-bands associated with a base station and one or more reconfigurable intelligent surfaces (RISs);
select at least one RIS of the one or more RISs and at least one sub-band of the one or more sub-bands, based on one or more constraints, and the channel measurements; and
transmit, to the base station, an indication of the at least one RIS the at least one sub-band, and the channel measurements.

10. The UE of claim 9, wherein the one or more processors are further configured to cause the UE to:
transmit the channel measurements to the base station via the at least one RIS of the one or more RISs.

11. The UE of claim 9, wherein the one or more processors are further configured to cause the UE to:
receive, from the base station, configuration information associated with the at least one RIS and the at least one sub-band.

12. The UE of claim 9, wherein the channel measurements comprise:
a signal-to-noise ratio of each sub-band of the one or more sub-bands,
a sum of signal-to-noise ratios associated with transmission polarizations,
a pathloss associated with direct signaling from the base station to the UE,
a pathloss associated with indirect signaling from the base station to the UE via the one or more RISs,
a reference signal received power associated with direct signaling from the base station to the UE,
a reference signal received power associated with indirect signaling from the base station to the UE via the one or more RISs,
a time difference of arrival associated with direct signaling from the base station to the UE,
a time difference of arrival associated with indirect signaling from the base station to the UE,
a delay difference estimation associated with direct signaling from the base station to the UE,
a delay difference estimation associated with indirect signaling from the base station to the UE via the one or more RISs, or
a combination thereof.

13. The UE of claim 9, wherein the one or more constraints comprise:
a signal-to-noise ratio threshold of each sub-band,
a path loss threshold,
reference signal received power threshold,
channel capacity threshold, or
a combination thereof.

14. The UE of claim 9, wherein the one or more processors are further configured to cause the UE to:
receive a channel measurement request from the base station or an interference device.

15. A base station, comprising:
a memory; and
one or more processors configured to, when executing instructions stored in the memory, cause the base station to:
perform channel measurements of one or more sub-bands associated with a user equipment (UE) and one or more reconfigurable intelligent surfaces (RISs);
receive, from the UE, an indication of at least one RIS of the one or more RISs and at least one sub-band of the one or more sub-bands that satisfy one or more constraints; and
select the at least one RIS based on the channel measurements, the indication of the at least one RIS and one or more additional constraints associated with the base station.

16. The base station of claim 15, wherein the one or more processors are further configured to cause the base station to:
transmit configuration information to configure the at least one RISs for communications between the base station and the UE via the at least one RIS; and
transmit an indication to the UE of the at least one RIS being selected.

17. The base station of claim 15, wherein the channel measurements comprise:
a signal-to-noise ratio of each sub-band of the one or more sub-bands,
a sum of signal-to-noise ratios associated with transmission polarizations,
a pathloss associated with direct signaling from the base station to the UE,
a pathloss associated with indirect signaling from the base station to the UE via the one or more RISs,
a reference signal received power associated with direct signaling from the base station to the UE,
a reference signal received power associated with indirect signaling from the base station to the UE via the one or more RISs, or
a combination thereof.

18. The base station of claim 15, wherein the channel measurements comprise:
a time difference of arrival associated with direct signaling from the base station to the UE,
a time difference of arrival associated with indirect signaling from the base station to the UE,
a delay difference estimation associated with direct signaling from the base station to the UE,
a delay difference estimation associated with indirect signaling from the base station to the UE via the one or more RISs, or
a combination thereof.

19. The base station of claim 15, wherein the one or more constraints comprise:
a signal-to-noise ratio threshold of each sub-band,
a path loss threshold,
reference signal received power threshold;
channel capacity threshold, or
a combination thereof.

20. The base station of claim 15, wherein the one or more processors are further configured to cause the base station to:
transmit a request for interference management to an interference device;
receive, from the interference device a channel measurement request; and
transmit one or more channel measurements to the interference device in response to the channel measurement request.
